(19) United States
(12) Patent Application Publication
(10) Pub. No.: US 2026/0345427 A1
(43) Pub. Date: Nov. 5, 2026

(54) DEVICES AND METHODS FOR MULTI-CHAMBER PNEUMATIC COMPRESSION

(71) Applicant: ManaMed, LLC, Denton, TX (US)

(72) Inventor: Trevor Theriot, Denton, TX (US)

(21) Appl. No.: 19/664,714

(22) Filed: Apr. 30, 2026

Related U.S. Application Data
(60) Provisional application No. 63/799,419, filed on May 3, 2025.

(51) Int. Cl. A61H 9/00

(52) U.S. Cl. CPC A61H 9/0078; A61H 2205/10

(57) ABSTRACT

A compression device is provided. The device may include a sleeve having a sleeve body and a bladder disposed on the sleeve body, the bladder having a number of chambers. The bladder may include a number of chamber ports, each of which may be disposed on a corresponding chamber of the number of chambers. The sleeve may further include a dock disposed on the sleeve body, which may be in fluid communication with each of the number of chamber ports. The device may further include a controller. The controller may be removably attached to the dock. The controller may include one or more pumps in fluid communication with the dock when the controller is attached to the dock, and a locking mechanism.

### CROSS-REFERENCES TO RELATED APPLICATIONS

This application is a non-provisional of and claims priority to and benefit of U.S. Provisional Patent Application No. 63/799,419, filed May 3, 2025, entitled “DEVICES AND METHODS FOR MULTI-CHAMBER PNEUMATIC COMPRESSION,” which is incorporated herein by reference in its entirety.

### STATEMENT REGARDING FEDERALLY SPONSORED RESEARCH OR DEVELOPMENT

Not applicable.

### REFERENCE TO SEQUENCE LISTING OR COMPUTER PROGRAM LISTING INDEX

Not applicable.

### BACKGROUND

The present invention relates generally to compression devices and methods. More particularly, the present disclosure pertains to multi-chamber compression sleeves.

Conventional compression devices are often applied to bodily extremities, such as feet, calves, and arms, in order to help promote blood flow back to the heart, prevent blood pooling, among other treatments and therapies. However, such devices typically lack flexibility in terms of clinical use as opposed to at-home use, the amounts and locations of applied pressure, and other use parameters. As such, in order to provide therapy over a wide variety of treatments and conditions, multiple such devices must be maintained (whether at home or in clinical settings). Moreover, such devices typically must periodically recharge a power supply required for operation, and such recharging is often cumbersome (e.g., positioning the device at or near an external power source in order to connect the power supply to such external power source). It would be advantageous to provide a device that resolves these and other issues.

What is needed, therefore, are improved compression devices, namely improved devices and methods for multi-chamber pressure treatment.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the present disclosure is a compression device (“device”). The device may be pneumatic. The device may include a sleeve. The sleeve may include a sleeve body and a bladder disposed on the sleeve body, the bladder having a number of chambers. The bladder may include a number of chamber ports. Each of the number of chamber ports may be disposed on a corresponding chamber of the number of chambers. The sleeve may further include a dock disposed on the sleeve body. The dock may be in fluid communication with each of the number of chamber ports. The dock may include an engagement surface.

The device may further include a controller. The controller may be removably attached to the dock. The controller may include a controller body and one or more pumps disposed on the controller body. The one or more pumps may be in fluid communication with the dock when the controller is attached to the dock. The controller may further include a locking element disposed on the controller body. The locking element may be configured to be angularly moved between a released position and an engaged position where the locking element engages the engagement surface.

In some embodiments, the controller includes a power supply disposed on the controller body and a charging port disposed on the controller body. The power supply may be in electrical communication with the one or more pumps. The charging port may be in electrical communication with the power supply and be configured to be connected to an external power source. Thus, the charging port may be configured to re-charge the power supply.

In some embodiments, the dock includes a number of dock ports. Each of the number of dock ports may be in fluid communication with a corresponding chamber port of the number of chamber ports. In some embodiments, the controller includes a number of controller ports disposed on the controller body and in fluid communication with the one or more pumps. Each of the number of controller ports may be in fluid communication with a corresponding dock port of the number of dock ports when the controller is attached to the dock.

In some embodiments, the number of dock ports engage the number of controller ports in a press-fit arrangement when the controller is attached to the dock. In some embodiments, when the controller is attached to the dock and the locking element is angularly moved to the engaged position, the locking element presses the number of controller ports into the number of dock ports, sealing the press-fit arrangement.

In some embodiments, each of the number of controller ports form a recess on a surface of the controller. Each of the dock ports may protrude from a surface of the dock, forming a protrusion profile that matches a recess profile formed by each of the number of controller ports.

In some embodiments, the sleeve further includes a number of tubes. Each of the number of tubes may fluidly couple a corresponding dock port of the number of dock ports to a corresponding chamber port of the number of chamber ports.

Another aspect of the present disclosure is a method of compressing a body part. The method may include providing the sleeve and removably attaching the aforementioned controller to the dock of the sleeve. The method may further include angularly moving the locking element of the controller from the released position to the engaged position where the locking element engages the engagement surface of the dock. The method may further include at least partially surrounding a limb with the sleeve. The method may further include activating the one or more pumps of the controller, such that at least one chamber of the bladder are inflated. In some embodiments, the method further includes angularly moving the locking element from the engaged position to the released position, such that the locking element disengages the engagement surface. Thus, the method may further include separating the controller from the sleeve. In some embodiments, the method further includes connecting the charging port to an external power source in order to re-charge the power supply.

Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a perspective view of a user wearing a compression device with a controller, according to some embodiments of the present disclosure.

FIG. 2 is a perspective view of a user wearing a compression device with a removable controller, according to some embodiments of the present disclosure.

FIG. 3 is a perspective view of a user wearing a compression device with a controller removably attached to a dock, according to some embodiments of the present disclosure.

FIG. 4 is a perspective view of a user wearing an expanded compression device, according to some embodiments of the present disclosure.

FIG. 5 is a perspective view of a user opening a compression device in order to release a limb from the compression device, according to some embodiments of the present disclosure.

FIG. 6 is a perspective view of a compression device with bladder having a number of inflation chambers, according to some embodiments of the present disclosure.

FIG. 7 is a front view of a compression device with a bladder having a number of inflation chambers, according to some embodiments of the present disclosure.

FIG. 8 is a rear view of an exemplary implementation of a compression device with a bladder having a number of inflation chambers, according to some embodiments of the present disclosure.

FIG. 9 is a front view of a bladder having a number of inflation chambers, according to some embodiments of the present disclosure.

FIG. 10 is a front view of an exemplary implementation of a bladder having a number of inflation chambers, according to some embodiments of the present disclosure.

FIG. 11 is a front internal view of a compression device with a bladder having a number of inflation chambers, according to some embodiments of the present disclosure.

FIG. 12 is a front view of an exemplary implementation of a compression device with a bladder having a number of inflation chambers, according to some embodiments of the present disclosure.

FIG. 13 is a side view of an exemplary implementation of a compression device with a bladder having a number of inflation chambers, according to some embodiments of the present disclosure.

FIG. 14 is an upper perspective view of a controller for a compression device, according to some embodiments of the present disclosure.

FIG. 15 is a lower view of a controller for a compression device, according to some embodiments of the present disclosure.

FIG. 16 is a left side view of a controller for a compression device, according to some embodiments of the present disclosure.

FIG. 17 is a right side view of a controller for a compression device, according to some embodiments of the present disclosure.

FIG. 18 is a rear view of a controller for a compression device, according to some embodiments of the present disclosure.

FIG. 19 is a rear view of an exemplary implementation of controller for a compression device, according to some embodiments of the present disclosure.

FIG. 20 is a detailed left side view of an exemplary implementation of a controller for a compression device, according to some embodiments of the present disclosure.

FIG. 21 is a detailed right side view of an exemplary implementation of a controller for a compression device, according to some embodiments of the present disclosure.

FIG. 22 is a front view of a dock for a compression device, according to some embodiments of the present disclosure.

FIG. 23 is a front view of an exemplary implementation of a dock for a compression device, according to some embodiments of the present disclosure.

FIG. 24 is an internal schematic view of a controller for a compression device, according to some embodiments of the present disclosure.

FIG. 25 is an internal schematic view of a controller for a compression device, according to other embodiments of the present disclosure.

FIG. 26 is an internal schematic view of a controller for a compression device, according to further embodiments of the present disclosure.

FIG. 27 is an internal view of an exemplary implementation of controller for a compression device, according to some embodiments of the present disclosure.

FIG. 28 is an internal view of an exemplary implementation of controller for a compression device, according to other embodiments of the present disclosure.

FIG. 29 is an internal view of an exemplary implementation of controller for a compression device, according to further embodiments of the present disclosure.

FIG. 30 is a perspective view of a user wearing a compression device with a controller in communication with an external transmitter, according to some embodiments of the present disclosure.

FIG. 31 is a front view of a bladder having a number of inflation chambers, according to further embodiments of the present disclosure.

FIG. 32 is a front internal view of a compression device with a bladder having a number of inflation chambers, according to some embodiments of the present disclosure.

FIG. 33 is a rear view of a controller for a compression device, according to further embodiments of the present disclosure.

FIG. 34 is a rear view of an exemplary implementation of controller for a compression device, according to further embodiments of the present disclosure.

FIG. 35 is a front view of a dock for a compression device, according to further embodiments of the present disclosure.

FIG. 36 is a front view of an exemplary implementation of a dock for a compression device, according to further embodiments of the present disclosure.

FIG. 37 is a detailed left side view of an exemplary implementation of a controller for a compression device, according to further embodiments of the present disclosure.

FIG. 38 is an internal view of an exemplary implementation of a controller for a compression device, according to further embodiments of the present disclosure.

FIG. 39 is a detail internal view of an exemplary implementation of a controller for a compression device, according to further embodiments of the present disclosure.

FIG. 40 is an internal schematic view of a controller for a compression device, according to additional embodiments of the present disclosure.

FIG. 41 is an exemplary implementation of a compression device with a removable controller, according to some embodiments of the present disclosure.

FIG. 42 is an exemplary implementation of a controller and a dock for a compression device, where the controller is being attached to the dock, according to some embodiments of the present disclosure.

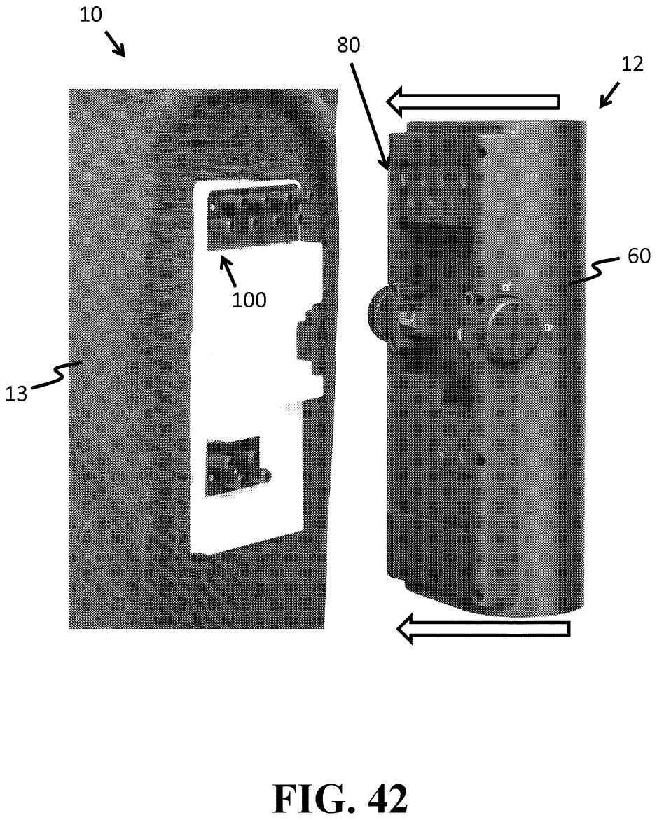

### DETAILED DESCRIPTION

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatuses, systems, and methods described herein. Such equivalents are considered to be within the scope of this disclosure and may be covered by the claims.

Furthermore, the described features, structures, or characteristics of the disclosure may be combined in any suitable manner in one or more embodiments. In the description contained herein, numerous specific details are provided, such as examples of programming, software, user selections, hardware, hardware circuits, hardware chips, or the like, to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

The aforementioned features and advantages of the embodiments will become more fully apparent from the description and appended claims, or may be learned by the practice of embodiments as set forth herein. As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer-readable media having program code embodied thereon.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

The words “connected”, “attached”, “joined”, “mounted”, “fastened”, “coupled,” and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

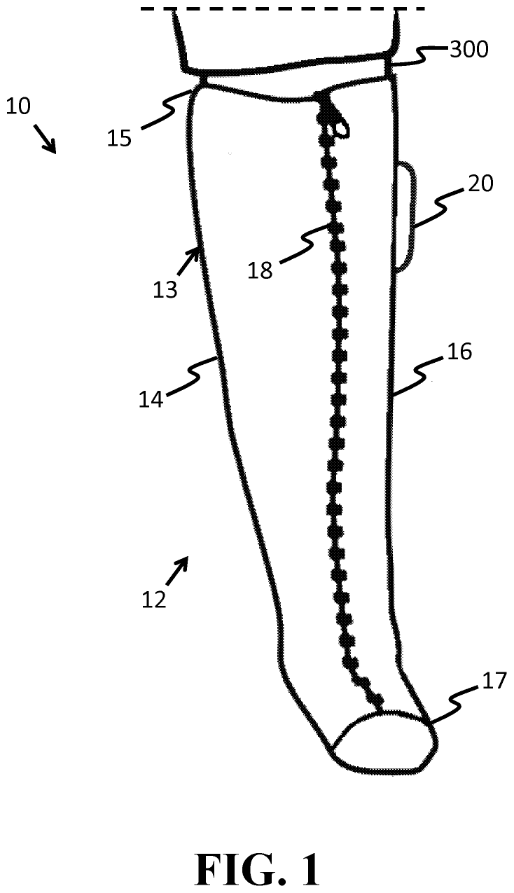

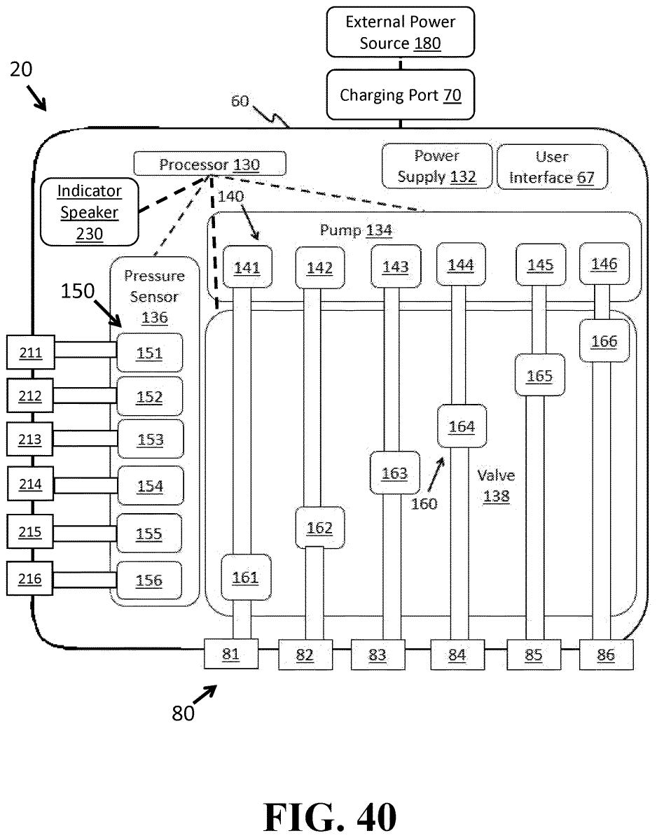

Referring now to FIGS. 1-3 and 40, a compression device (“device”) 10 is shown, according to various embodiments of the present disclosure. Depending on the implementation, the device 10 may be a pneumatic compression device. In other words, the device 10 may be configured to provide pneumatic compression therapy. In some embodiments, the device 10 is a gradient compression device, and is configured to provide graduated compression in both sustained and intermittent settings for use in hospital, outpatient, and at-home settings. In some embodiments, the device 10 is a cordless pneumatic compression device.

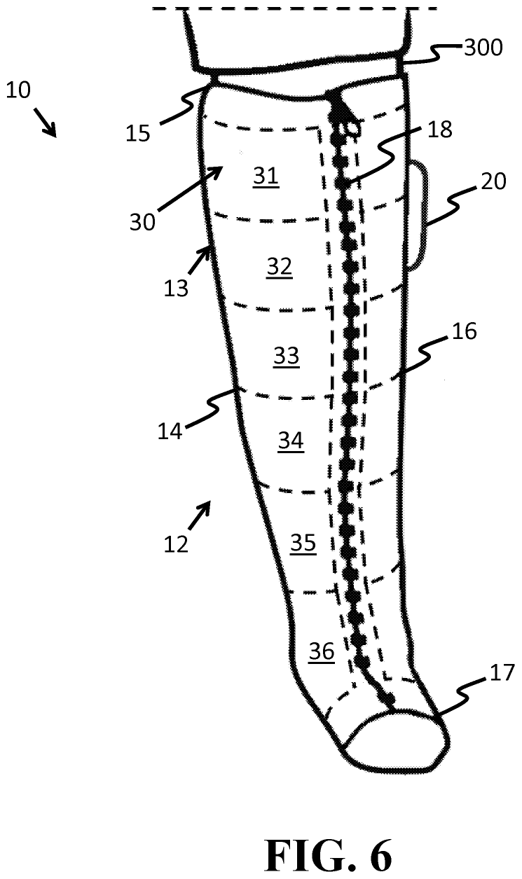

In some embodiments, the device 10 may include a sleeve 12. Depending on the implementation, the sleeve 12 may be a pneumatic compression sleeve. The sleeve 12 may include a sleeve body 13. As depicted with additional reference to FIG. 6, the sleeve 12 may include a bladder 30 disposed on the sleeve body 13.

The bladder 30 may be inflated in order to provide compression therapy. For example, as discussed in greater detail below, the bladder 30 may include a number of chambers. In some embodiments, the chambers of the bladder 30 are inflated in order to provide graduated compression (e.g., applying more pressure distally while gradually decreasing pressure as the sleeve 12 travels up a limb). Depending on the implementation, the bladder 30 may be inflated in order to apply intermittent compression for use in home and clinical settings. As non-limiting examples, the device 10 may be configured as a pneumatic compression device in order to provide a number of treatments, including but not limited to: (a) treatment of lymphedema, (b) treatment of chronic venous insufficiency, (c) treatment and healing of stasis dermatitis, (d) reducing venous leg ulcer healing time, (e) treatment and healing of venous stasis ulcers, (f) reducing edema due to venous statis, and (f) enhancing venous return.

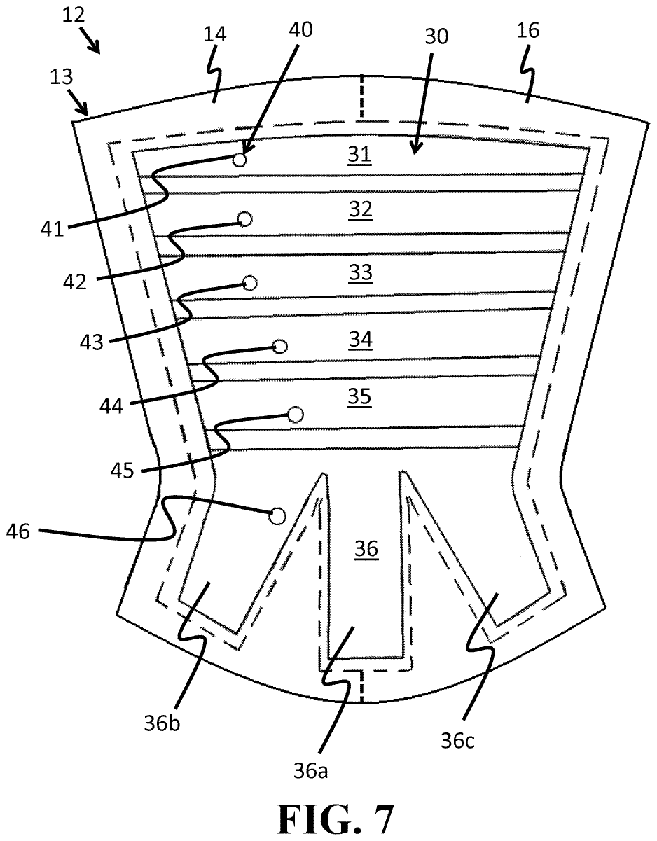

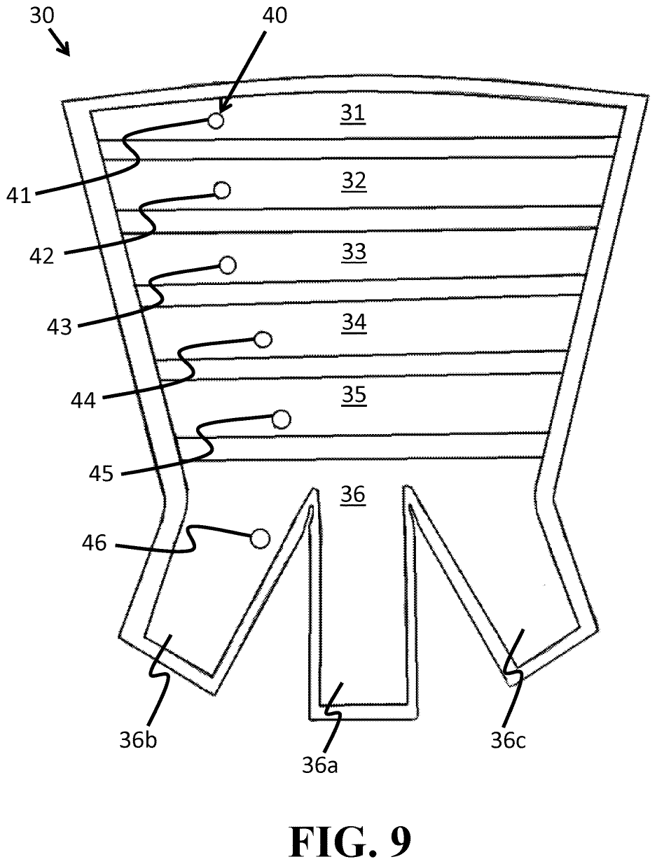

As depicted with additional reference to FIGS. 7, 9, 11, 31, and 32, the bladder 30 may include a number of chamber ports (e.g., inflow ports) 40. Each of the number of chamber ports 40 may be disposed on a corresponding chamber of the bladder 30. In other words, the chambers may each include a corresponding chamber port of the number of chamber ports 40. Thus, air or some other suitable gas may be injected into each chamber of the bladder 30 via the number of chamber ports 40. In this sense, the chamber ports 40 may be configured to receive gas for inflation.

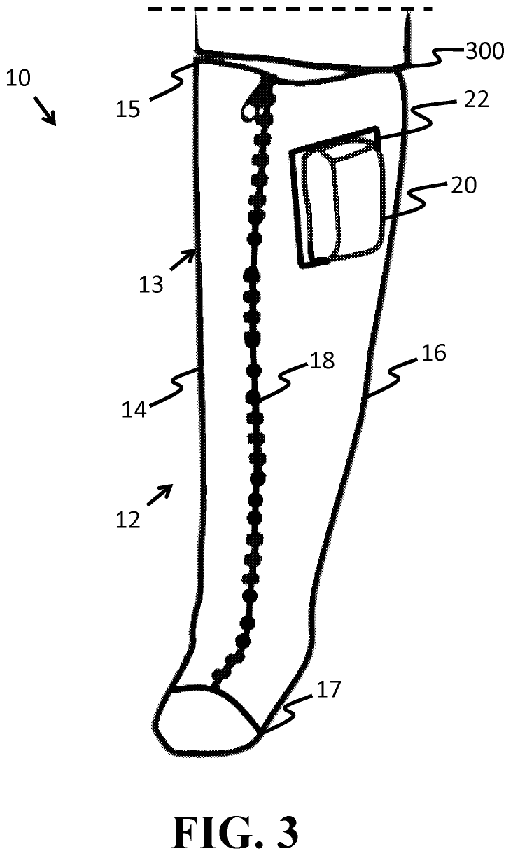

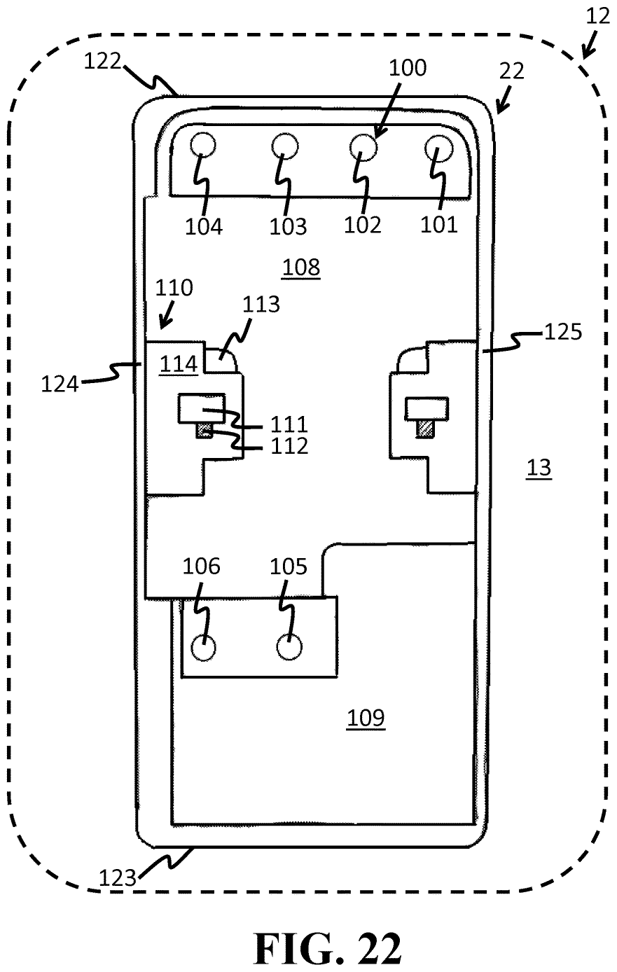

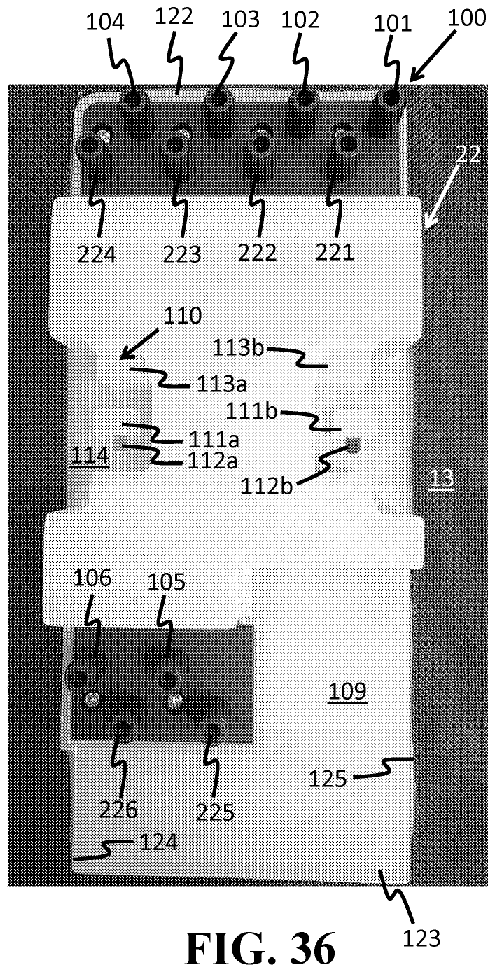

In some embodiments, and as shown with particular reference to FIG. 3, the sleeve 12 includes a dock 22 disposed on the sleeve body 13. The dock 22 may be in fluid communication with each of the number of chamber ports 40, and thus each chamber of the bladder 30. As shown with additional reference to FIGS. 22, 23, 35, and 36, the dock 22 may include an engagement surface 110. For instance, as discussed in greater detail below, the device 10 may further include a controller 20. The engagement surface 110 may be configured to receive and mechanically engage the controller 20 in order to removably secure the controller 20 to the dock 22, and therefore the sleeve 13. Depending on the implementation, the controller 20 may be a wireless communication device configured to adjust a pressure in each chamber of the bladder 30. For instance the controller 20 may be a battery-powered controller removably attached to the dock 22.

As discussed above, the device 10 may include the sleeve 12 and the controller 20. The sleeve 12 may include the sleeve body 13, the bladder 30 having the number of chambers, and the dock 22 in fluid communication with the number of chambers. The controller 20 removably attached to the dock 22.

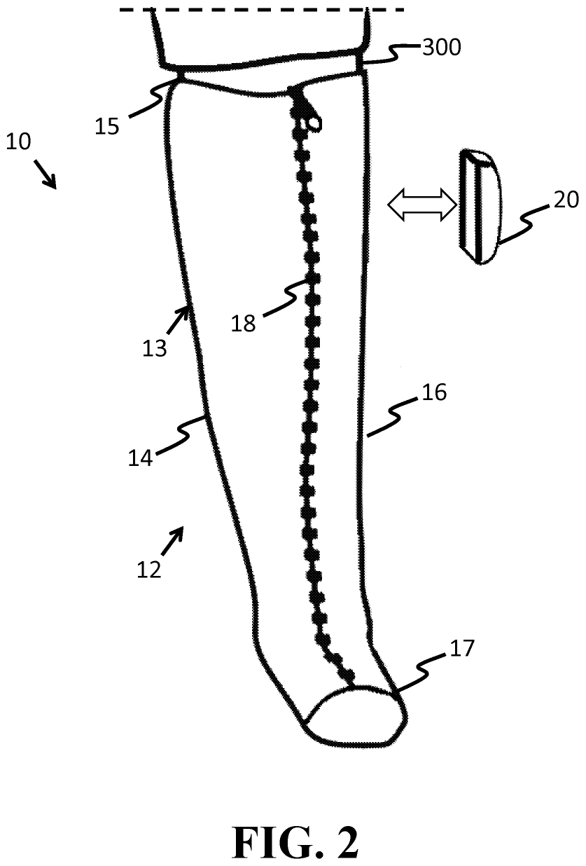

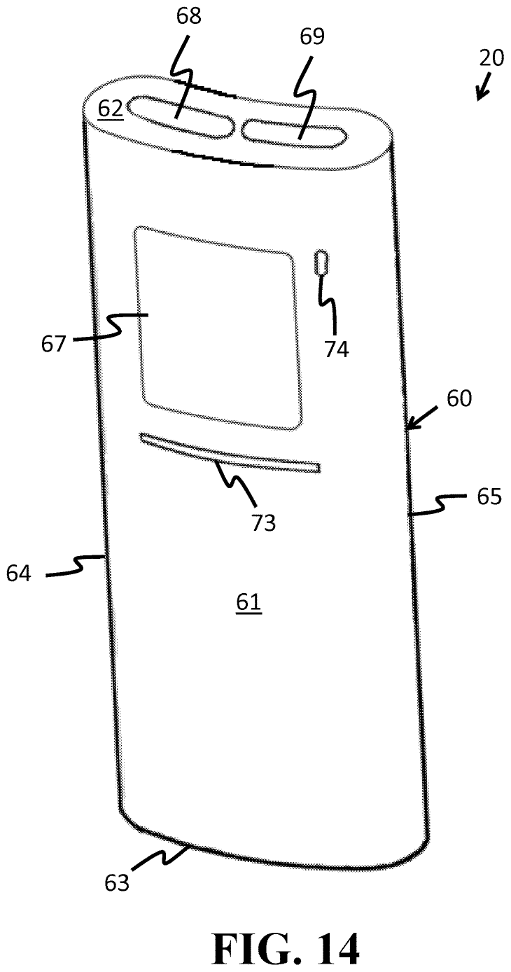

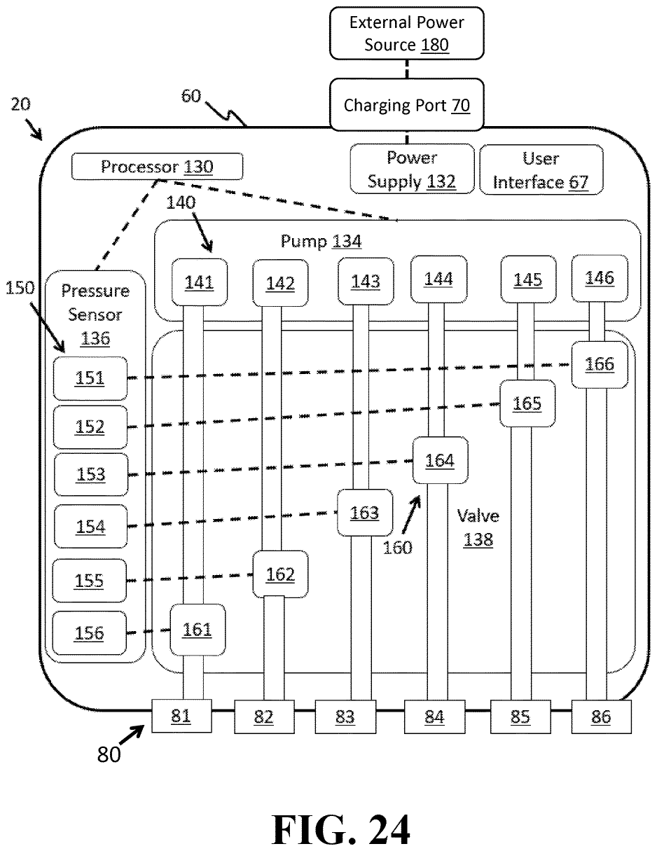

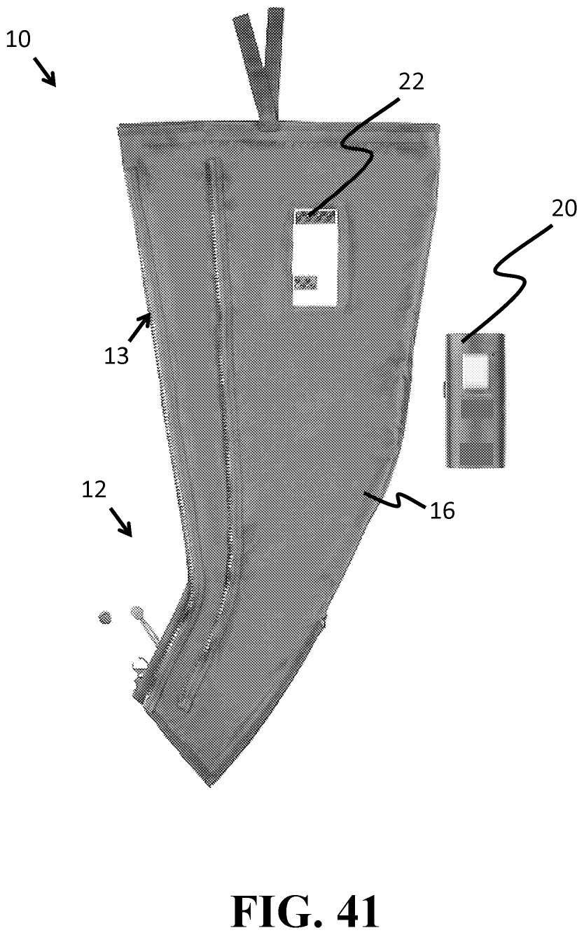

In some embodiments, and as mentioned above and depicted with additional reference to FIG. 41, the device 10 further includes the controller 20. The controller 20 may be detachably secured to the sleeve body 13 (e.g., via the dock 22), such that the controller 20 may be attached to the sleeve 13 in order to operate the pneumatic compression provided by the bladder 30, while also being removable for power-charging and other purposes. As depicted with particular reference to FIGS. 2 and 3, the controller 20 may be removably attached to the dock 22. As shown with additional reference to FIG. 14, the controller 20 may include a controller body 60. As shown with additional reference to FIGS. 24-26 and 40, the controller 20 may further include one or more pumps 140 disposed on the controller body 60. The one or more pumps 140 may be in fluid communication with the dock 22 when the controller 20 is attached to the dock 22, and thus the chambers of the bladder 30. As discussed in greater detail below, the one or more pumps 140 may be configured to deliver gas to the inflatable chambers of the bladder 30 through the dock 22 when the controller 20 is attached to the dock 22. Thus, the one or more pumps 140 may be configured to inflate one or more chambers of the bladder 30 disposed on the sleeve body 13.

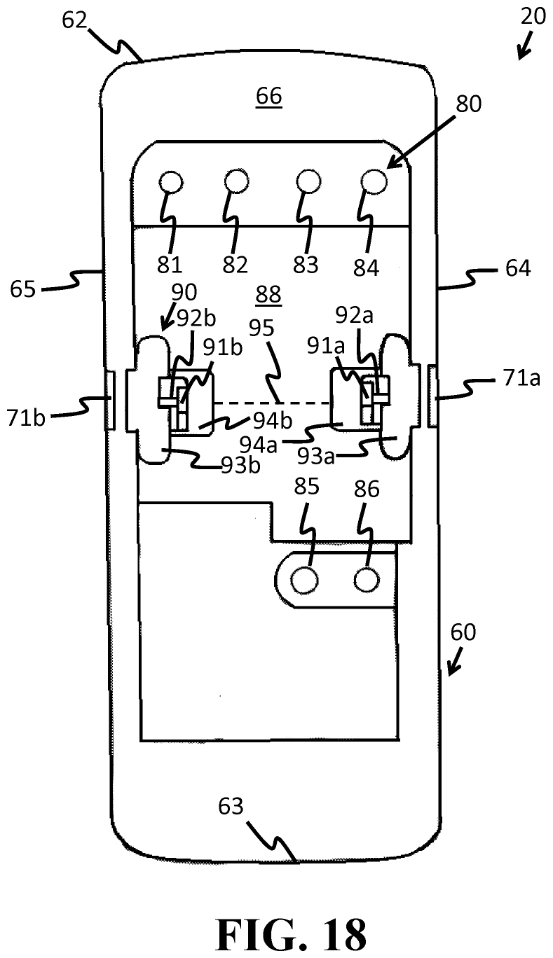

The dock 22 and the controller 20 may each include corresponding features in order to removably attach the controller 20 to the dock 22. For example, and as mentioned above, the dock 22 may include the engagement surface 110. In some embodiments, and as shown with additional reference to FIGS. 18, 19, 33, and 34, the controller 20 further includes a locking mechanism, which may include a locking element 90 disposed on the controller body 60 (e.g., supported by the controller body 60) that corresponds to the engagement surface 110. For example, the locking element 90 (or a component thereof) may be a displaceable locking member configured to be angularly moved between a released position where the controller 20 may be separated from the dock 22, and an engaged position where the locking element 90 engages the engagement surface 110, such that the controller 20 is secured (e.g., attached, removably secured, removably attached, etc.) to the dock 22. Accordingly, the controller 20 may include the controller body 60, the one or more pumps 140 in fluid communication with the dock 22, and the locking mechanism (e.g., the locking element 90) positioned to secure the controller 20 to the dock 22.

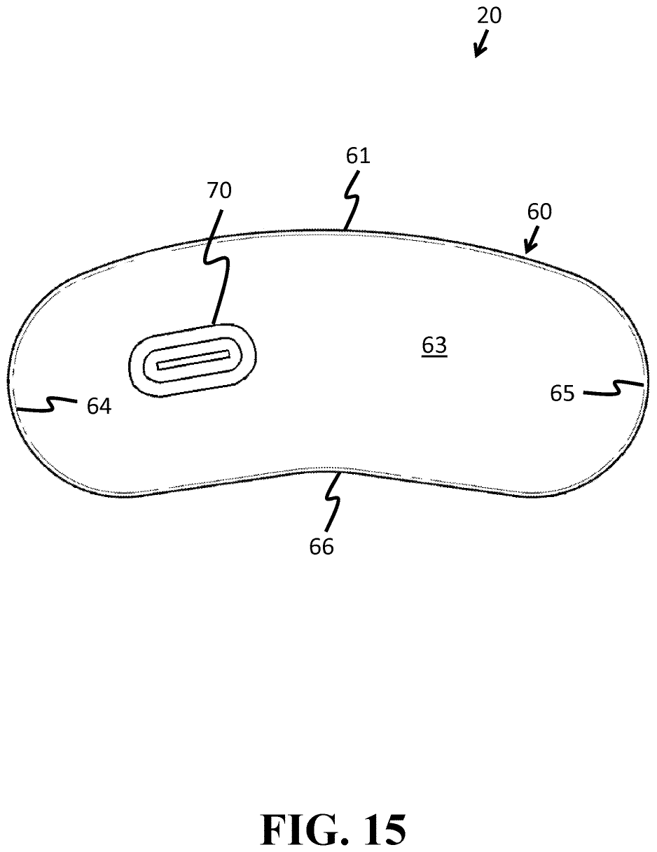

In some embodiments, and as shown with additional reference to FIGS. 24-26 and 40, the controller 20 further includes a power supply 132 disposed on the controller body 60. In some embodiments, the power supply 132 may include a battery which, depending on the implementation, is a 3.7V, 4500 mAH battery. Further, and as shown with additional reference to FIG. 15, the controller 20 may further include a charging port 70 disposed on the controller body 60. The power supply 132 may be in electrical communication with the one or more pumps 140. The charging port 70 may be in electrical communication with the power supply 132 and, as shown with additional reference to FIGS. 24-26 and 40, be configured to be connected to an external power source 180. Thus, the charging port 70 may be configured to re-charge the power supply 132. Advantageously, the controller 20 may be temporarily detached from the dock 22 and be recharged by coupling the power supply 132 to the external power source 180 via the charging port 70. Accordingly, the controller 20 may include the charging port 70, which may be considered a power supply port 70 configured for engaging with such the external power source 180.

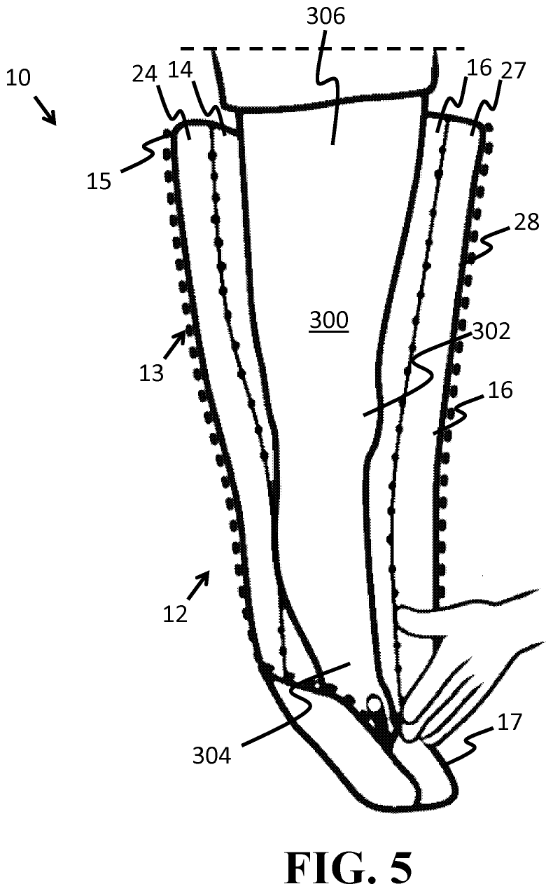

As shown, the device 10 may be worn on a limb, such as a leg 300, according to some embodiments of the present disclosure. As mentioned above, the device 10 may include a sleeve 12, which may include the sleeve body 13. The sleeve body 13 may include an upper end 15 and a lower end 17. As shown with additional reference to FIG. 5, the sleeve body 13 may be dimensioned such that, when the sleeve 12 is worn on the leg 300, the upper end 15 is positioned above a knee 302 of the leg 300. In other words, the sleeve 12 may be worn on the leg 300 such that the lower end 17 supports a foot 304 of the leg 300, while the upper end 15 is positioned about a thigh 306 of the leg 300 above the knee 302.

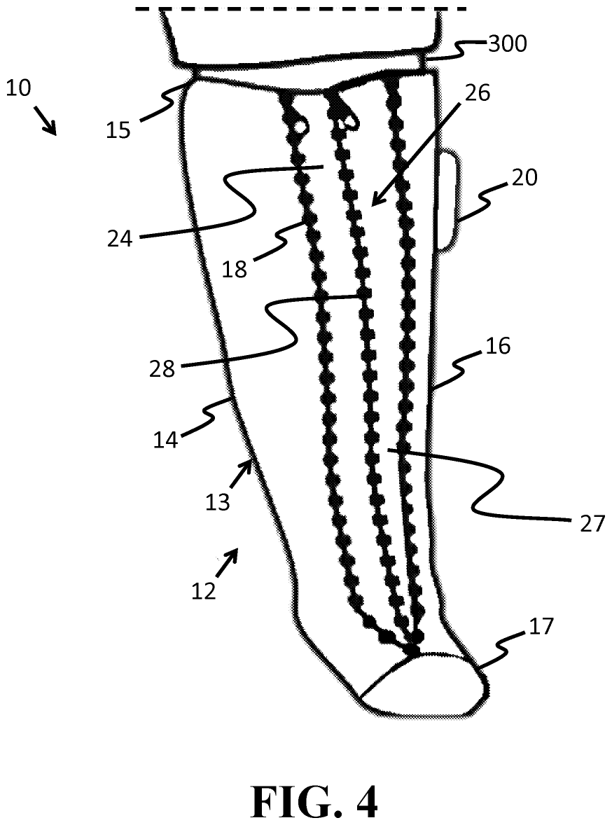

In some embodiments, the sleeve 12 includes a first zipper 18 disposed on the sleeve body 13. In some embodiments, the first zipper 18 extends a vertical length of the sleeve body 13, from the upper end 15 to the lower end 17. The first zipper 18 may attach a first end 14 of the sleeve body 13 to a second end 16 of the sleeve body 13, such that the sleeve body 13 may be wrapped around and secured about the leg 300. The sleeve body 13 extending between the first and second ends 14, 16 may be considered an outer panel of the sleeve body 13. For instance, the first zipper 18, when closed, may conceal an inner panel of the sleeve body 13. In this sense, the first zipper 18 may be considered as being disposed on such outer panel of the sleeve body 13. As discussed in greater detail below with reference to FIG. 4, the sleeve body 13 may further include an inner panel 26, which may be expanded in order to facilitate use of the device 10 with larger legs.

Referring now to FIGS. 4 and 5, the inner panel 26 of the sleeve body 13 is shown, according to some embodiments of the present disclosure. As mentioned above, the sleeve body 13 may further include the inner panel 26, which may be expanded in order to facilitate use of the device 10 with larger legs. In this sense, separation of the first zipper 18 may reveal the inner panel 26 in order to expand a circumference of the sleeve body 13 for use with larger limbs (e.g., larger legs). In some embodiments, the first zipper 18 may be separated in order to reveal the inner panel 26, which may be attached to the first and second ends 14, 16 of the sleeve body 13 at lateral ends of the inner panel 26.

In some embodiments, the sleeve 12 further includes a second zipper 28. The second zipper 28 may extend along the vertical length of the inner panel 26 from the upper end 15 to the lower end 17. As shown with particular reference to FIG. 5, the second zipper 28 may be separated (e.g., is separable) in order to open the sleeve 12 and remove the device 10 from a limb (e.g., the leg 300). When the second zipper 28 is separated, the inner panel 26 may be separated into a first inner panel component 24 attached to the first end 14 of the sleeve body 13 (by a corresponding half of the first zipper 18), and a second inner panel component 27 attached to the second end 16 of the sleeve body 13 (by a corresponding half of the first zipper 18).

Referring now to FIG. 6, a partial interior view of the device 10 is shown, according to some embodiments of the present disclosure. As mentioned above, the sleeve 12 may include the bladder 30. In some embodiments, the bladder 30 includes six chambers. For example, the bladder 30 may include a first chamber 31, a second chamber 32, a third chamber 33, a fourth chamber 34, a fifth chamber 35, and a sixth chamber 36. Of course, it should be appreciated that the bladder 30 may include more (e.g., seven, eight, nine,) or less (e.g., five, four, three) chambers.

As mentioned above, the bladder 30 may be disposed on the sleeve body 13. For example, the bladder 30 may be embedded within multiple layers of material making up the sleeve body 13. As shown, the chambers of the bladder 30 may be arranged on the sleeve body 13 in sequential order. For instance, the chambers of the bladder 30 may be arranged in a descending (or ascending) sequential order along the vertical profile of the leg 300 when the device 10 is worn on the leg 300. For example, the first chamber 31 may be closest chamber of the bladder 30 to the upper end 15 of the sleeve body 13; the second chamber 32 may be further from the upper end 15 than the first chamber 31; the third chamber 33 may be further from the upper end 15 than the first and second chambers 31, 32; the fourth chamber 34 may be further from the upper end 15 than the first, second, and third chambers 31, 32, 33; the fifth chamber 35 may be further from the upper end 15 than the first, second, third and fourth chambers 31, 32, 33, 34; and the sixth chamber 36 may be closest chamber of the bladder 30 to the lower end 17 of the sleeve body 13, and be further from the upper end 15 than the first, second, third, fourth, and fifth chambers 31, 32, 33, 34, 35.

As mentioned above, the bladder 30 may be inflated such that the sleeve 12 provides varying compression to a limb, such as the leg 300. In this sense, the bladder 30 (e.g., the chambers thereof) may be inflated such that the lower-most inflatable bladder, such as the sixth chamber 36, is inflated to the highest pressure and thus applies the highest pressure on the limb, and such pressure decreases upwardly, such that the highest inflatable bladder, such as the first chamber 31, is inflated to the lowest pressure and thus applies the lowest pressure on the limb.

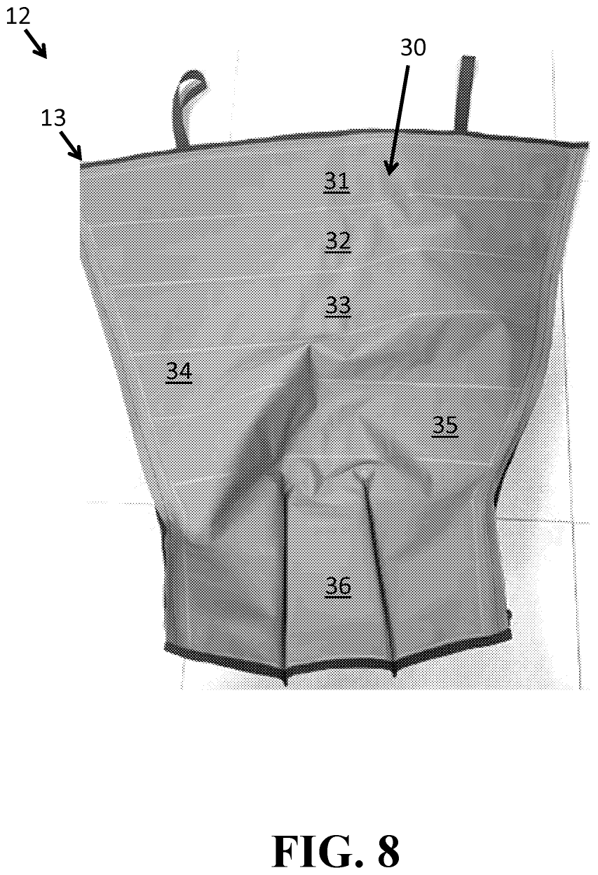

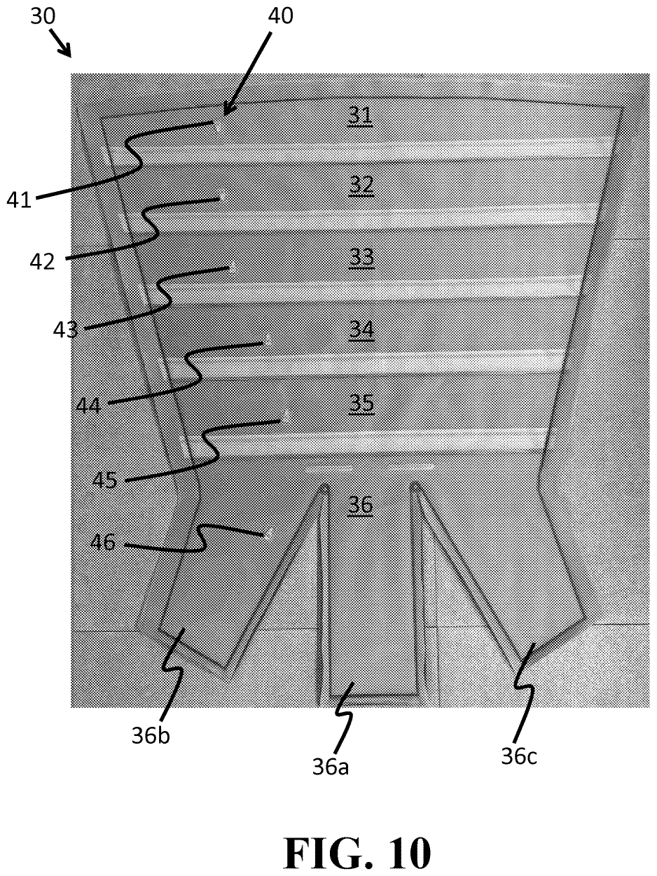

Referring now to FIGS. 7-10, the bladder 30 and the chambers thereof are shown in greater detail, according to some embodiments of the present disclosure. As mentioned above, the bladder 30 may be disposed on the sleeve body 13. In some embodiments, the bladder 30 is embedded within multiple layers of material constituting the sleeve body 13. In other embodiments, the bladder 30 is attached to the sleeve body 13. In other embodiments still, the bladder 30 is disposed on an exterior of the sleeve body 13.

As suggested above, some or all chambers of the bladder 30 may be disposed within the material of the sleeve 12. In other words, each chamber of the bladder 30 may be located in between the interior and exterior sides of the sleeve body 13. For example, the interior side of the sleeve body 13 may be constructed of one set or more sheets of material, while the exterior side of the sleeve body 13 may be constructed of a corresponding set of one or more sheets of material. The bladder 30, in turn, may be situated in between such corresponding sets of one or more sheets of material.

In some embodiments, the bladder 30 is secured within (or to) the sleeve body 13 via one or more strips of adhesive. For example, the bladder 30 may be secured to an interior side or an exterior side of the sleeve body 13 via one or more strips of adhesive. In some embodiments, the chambers of the bladder 30 may be separated by a perforated edge forming an air-tight border within the bladder 30. Thus, each chamber of the bladder 30 may be filled with air or some other suitable fluid via the corresponding number of chamber ports 40.

As discussed in greater detail below, the device 10 may include various components configured to provide a gas (e.g., air) to one or more chambers of the bladder 30 in order to inflate the chambers of the inflatable bladder 30. Accordingly, and as mentioned above, the sleeve 12 may include the number of chamber ports 40 each disposed on and in fluid communication with a corresponding chamber of the bladder 30. For example, the sleeve 12 may include a first chamber port 41 disposed on and in fluid communication with the first chamber 31; a second chamber port 42 disposed on and in fluid communication with the second chamber 32; a third chamber port 43 disposed on and in fluid communication with the third chamber 33; a fourth chamber port 44 disposed on and in fluid communication with the fourth chamber 34; a fifth chamber port 45 disposed on and in fluid communication with the fifth chamber 35; and a sixth chamber port 46 disposed on and in fluid communication with the sixth chamber 36.

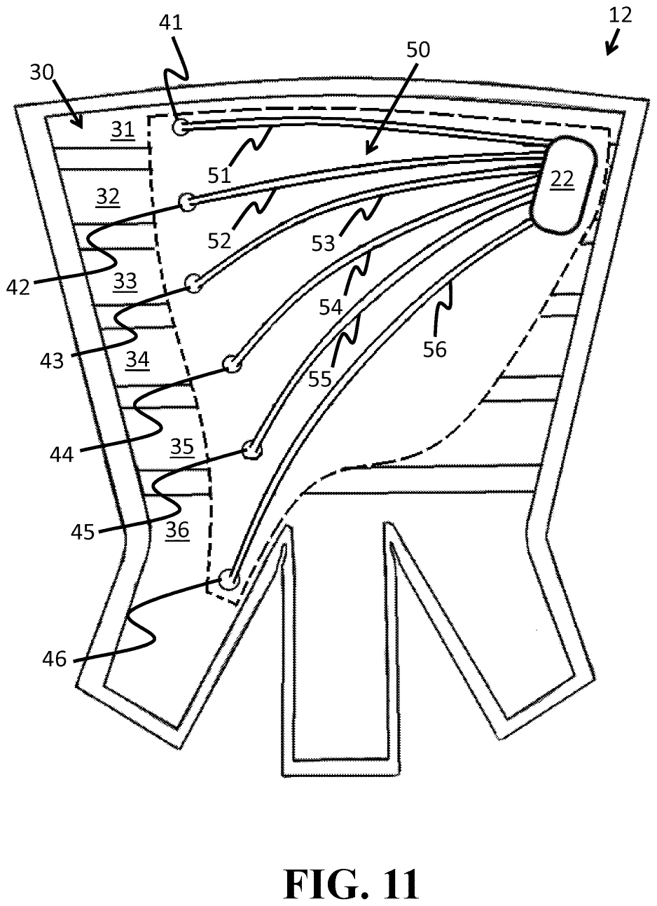

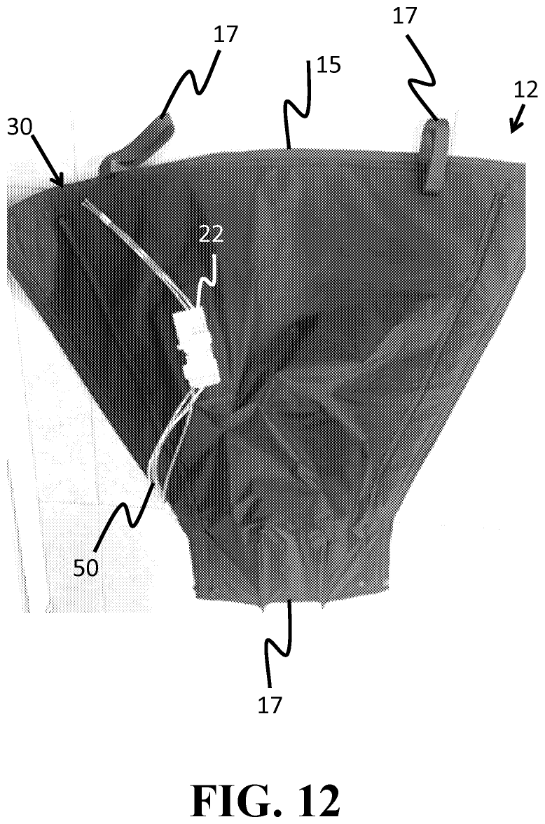

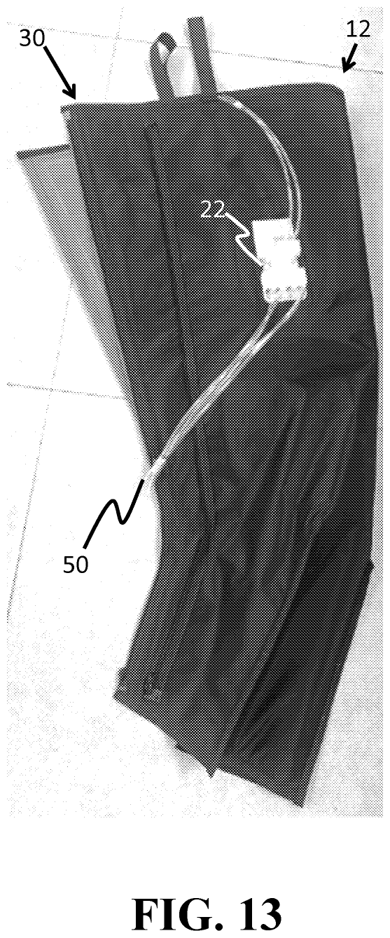

Referring now to FIGS. 11-13, the chambers of the bladder 30 are shown in fluid communication with the dock 22, according to some embodiments of the present disclosure. As discussed in greater detail below, the dock 22 may be configured to receive and engage the controller 20, which may provide a supply of gas or air for inflating the bladder 30. In turn, the dock 22 may be in fluid communication with the bladder 30 (or, in other words, each chamber thereof). For example, and as shown with additional reference to FIGS. 22, 23, 35, and 36, the dock 22 may include a number of dock ports 100. Each of the number of dock ports 100 may be in fluid communication with a corresponding chamber port of the number of chamber ports 40, and thus the corresponding chamber of the bladder 30.

In some embodiments, the sleeve 12 may further include a number of tubes 50. Each of the number of tubes 50 may fluidly couple a corresponding dock port of the number of dock ports 100 to a corresponding chamber port of the number of chamber ports 40. Thus, the number of tubes 50 may extend between the dock 22 and the number of chamber ports 40 disposed on the bladder 30. For example, the sleeve 12 may include a first tube 51 disposed on and fluidly coupling the first chamber port 41 to the dock 22; a second tube 52 disposed on and fluidly coupling the second chamber port 42 to the dock 22; a third tube 53 disposed on and fluidly coupling the third chamber port 43 to the dock 22; a fourth tube 54 disposed on and fluidly coupling the fourth chamber port 44 to the dock 22; a fifth tube 55 disposed on and fluidly coupling the fifth chamber port 45 to the dock 22; and a sixth tube 56 disposed on and fluidly coupling the sixth chamber port 46 to the dock 22.

Referring now to FIG. 14, the controller 20 is shown in greater detail, according to some embodiments of the present disclosure. In some embodiments, the controller 20 is a generally rectangular user device configured to receive user inputs and, based on the user inputs, effectuate inflation of the bladder 30. The controller 20 may include a controller body 60 that houses and/or mechanically arranges the various components of the controller 20. Depending on the implementation, the controller body 60 may form a generally rectangular shape. For instance, the controller body 60 may include a front side 61, a left side 64, a right side 65, a top side 62, a bottom side 63, and a back side 66 (shown with additional reference to FIGS. 15-19).

In some embodiments, the controller 20 includes a user display 67 disposed on the front side 61 of the controller 20. The user display 67 may indicate various operational indications to a user when wearing and/or operating the device 10. Depending on the implementation, the user display 67 may be a liquid crystal display (LCD), a cathode ray tube (CRT), a touch screen, or some other suitable display. As shown with additional reference to FIGS. 24-26, the controller 20 may include a processor 130 housed within the controller body 60. The processor 130 may include processor circuity and a data storage. The processor 130 may be configured to, among other processes, generate for presentation on display (via the user display 67) one or more user interfaces in order to allow a user to select and activate various treatment procedures.

As used herein, the term “circuitry” may refer to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD), (e.g., a field-programmable gate array (FPGA), a programmable logic device (PLD), a complex PLD (CPLD), a high-capacity PLD (HCPLD), a structured ASIC, or a programmable System on Chip (SoC)), digital signal processors (DSPs), etc., that are configured to provide the described functionality. In some embodiments, the circuitry may execute one or more software or firmware programs to provide at least some of the described functionality. In addition, the term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

As used herein, the term “processor circuitry” may refer to, is part of, or includes circuitry capable of sequentially and automatically carrying out a sequence of arithmetic or logical operations; recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable

As used herein, the term “user interface” (also referred to as an interactive user interface, a graphical user interface or a UI), may refer to a computer-provided interface including data fields or other controls for receiving input signals or providing electronic information or for providing information to a user in response to received input signals. A user interface may be implemented, in whole or in part, using technologies such as hyper-text mark-up language (HTML), a programming language, web services, or rich site summary (RSS). In some implementations, a user interface may be included in a stand-alone client software application configured to communicate in accordance with one or more of the aspects described.

In some embodiments, the controller 20 includes various buttons configured to receive user inputs. For example, the controller 20 may include a first button 68 and a second button 69. In some embodiments, the first button 68 is disposed on the top side 62 and is configured, when pressed, to provide a notification to the processor 130 in order to activate or deactivate the device 10. In some embodiments, the second button 69 is disposed on the top side 62 and is configured, when pressed, to send one or more notifications to the processor 130 in order to cycle through and receive a selection amongst various operational settings for inflation of the bladder 30 via the controller 20. For example, such operational settings may be displayed on the user display 67. In some embodiments, such operational settings include a duration of treatment (e.g., a duration of time during which the chambers of the bladder 30 are inflated in order to provide compression therapy). In further embodiments, such operational settings include a maximum inflation pressure to be obtained within each chamber of the bladder 30. Such maximum pressure may be selected based on a singular value (e.g., a pressure at which to inflate all chambers of the bladder 30, a pressure at which to inflate a single chamber of the bladder 30, which corresponds to a decreasing pressure for each adjacent chamber of the bladder 30, etc.).

In some embodiments, the processor 130 includes a data storage in which such operational settings may be stored. As used herein, the term “data storage” may include a tangible device that retains and stores data. Such device may include an electronic storage device, a magnetic storage device, an optical storage device, an electromagnetic storage device, a semiconductor storage device, or any suitable combination of the foregoing. A non-exhaustive list of more specific examples of the devices may include a portable computer diskette, a random access memory (RAM), a read-only memory (ROM), an erasable programmable read-only memory (EPROM or flash memory), a static random access memory (SRAM), a hard disk drive (HDD), a solid state drive, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. “Data storage,” in some embodiments, may include a data structure that stores data, and the data structure may be stored on a tangible data storage. Such data storage may include a file system, a database, cloud storage, a data warehouse, a data lake, or other data structures configured to store data.

In some embodiments, the controller 20 includes various indicator lights configured to further provide various operational indications to a user when wearing and/or operating the device 10. For example, the controller 20 may include a first indicator light 73 disposed on the front side 61 of the controller body 60, and a second indicator light 74 disposed on the front side 61 of the controller body 60. In some embodiments, one of the indicator lights 73, 74 may be illuminated when the device 10 is activated. In other embodiments, one of the indicator lights 73, 74 may be illuminated when the device 10 is being charged as discussed herein. In other embodiments still, one of the indicator lights 73, 74 may be illuminated when a treatment process is being conducted by the device 10.

Referring now to FIG. 15, the bottom side 63 of the controller 20 is shown, according to some embodiments of the present disclosure. As mentioned above, the controller 20 may include the power supply 132 disposed on the controller body 60 and, as shown, the charging port 70 disposed on the controller body 60. In particular, the charging port 70 may be disposed on the bottom side 63 of the controller body 60. The charging port 70 may be configured to re-charge the power supply 132, and thus may be in electrical communication with the power supply 132. The power supply 132 may be in electrical communication with the processor 130, and various other components of the controller 20.

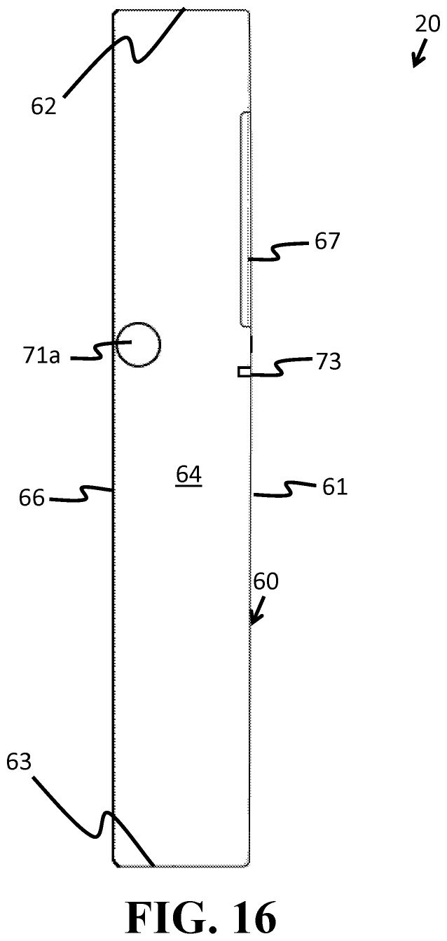

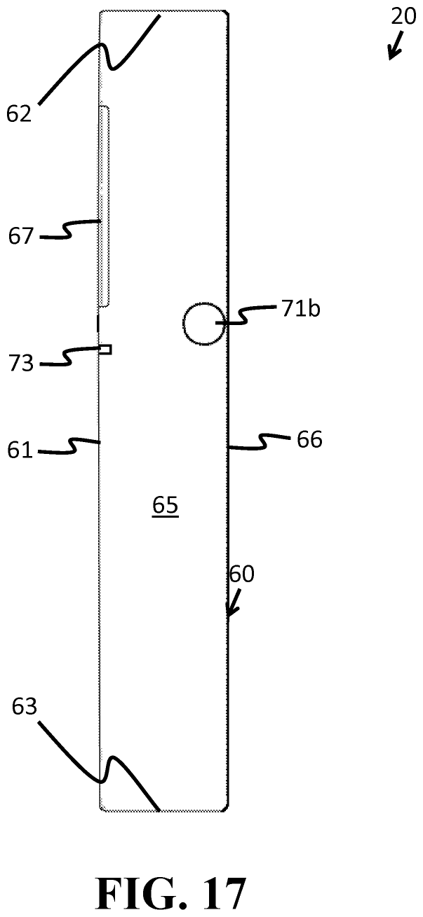

Referring now to FIGS. 16 and 17, the left and right sides 64, 65 of the controller 20 are shown, according to various embodiments of the present disclosure. As mentioned above, the controller 20 further includes the locking element 90 disposed on the controller body 60, which may be positioned to secure the controller 20 to the dock 22. For example, the locking element 90 may be configured to be angularly moved between a released position and an engaged position where the locking element 90 engages the engagement surface 110. In some embodiments, the locking element 90 includes an actuation member 71 (e.g., a lock operation element) connected thereto. The actuation member 71 may be disposed on the controller body 60 and angularly movable relative thereto. Thus, a user may manipulate the actuation member 71 in order to effectuate the aforementioned angular movement of the locking element 90. Depending on the implementation, the actuation member 71 may be a knob, such that a user may drive the actuation member 71 with a thumb. In some embodiments, the controller 20 includes two such actuation members; a first actuation member 71a and a second actuation member 71b. The first actuation member 71a may be disposed on the left side 64 of the controller body 60, and the second actuation member 71b may be disposed on the right side 65 of the controller body 60.

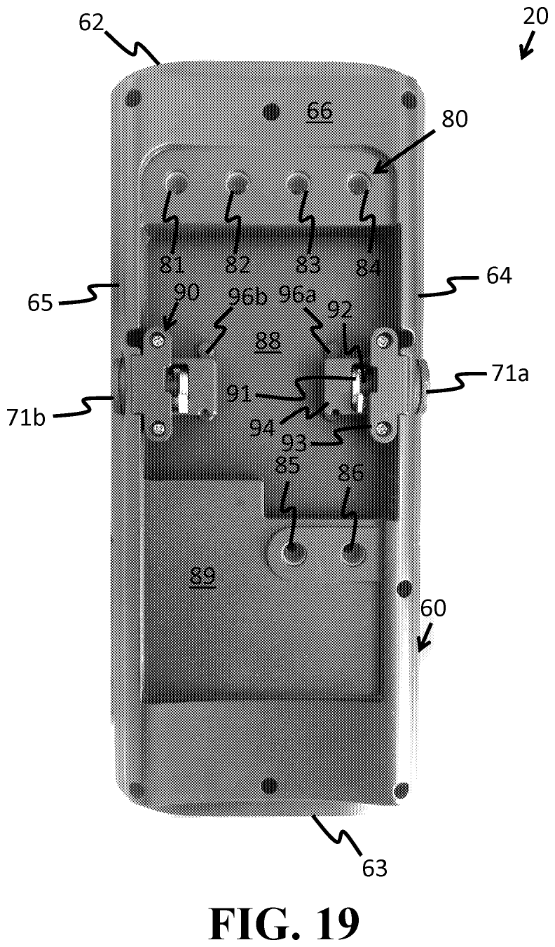

Referring now to FIGS. 18 and 19, the back side 66 of the controller 20 is shown, according to some embodiments of the present disclosure. As mentioned above, the controller 20 may include the locking element 90 disposed on the controller body 60. As shown, the locking element 90 may be disposed on the back side 66 of the controller body 60. In some embodiments, the locking element 90 includes a hook 91. The hook 91 may be attached to an axle 92, which may be configured to drive angular movement of the hook 91 in order to engage or release the engagement surface 110 of the dock 22 discussed in greater detail below. In some embodiments, the axle 92 is attached to the actuation member 71 such that a user may operate the actuation member 71 (e.g., rotate the actuation member 71) in order to drive angular movement of the hook 91 in order to engage or release the engagement surface 110 of the dock 22.

In some embodiments, the hook 91 is positioned in a depression 88 formed on the back side 63 of the controller body 60. In this sense, the axle 92 may extend through an outer perimeter of the controller body 60 forming a border to the depression 88, through a sleeve 93 disposed on the controller body 60 in the depression 88, through the hook 91 to which it is attached, and be received by a bearing 94 disposed on the controller body 60 in the depression 88. In some embodiments, a stand-off 96 protrudes upwardly from the depression 88 adjacent to the bearing 94. In some embodiments, the sleeve 93 includes a rotational sensor configured to detect the angular position of the axle 92, and thus the hook 91. The rotational sensor may be in electrical communication with the processor 130, which may be configured to only allow initiation of a treatment process when the rotational sensor detect an angular position of the axle 92 that corresponds to a locked engagement between the locking element 90 and the engagement surface 110 of the dock 22. Depending on the implementation, the processor 130 may be configured to only permit initiation of the treatment process(es) discussed herein when the rotational sensor indicates that the locking element 90 is in the engaged position.

In some embodiments, the locking element 90 includes a first hook 91a and a second hook 91b. Each of the first hook 91a and the second hook 91b may be configured similar to the hook 91 as discussed above (e.g., be configured to be angularly moved in order to engage or release the engagement surface 110 of the dock 22).

As a first example, the first hook 91a may be attached to a first axle 92a, which may be configured to drive angular movement of the first hook 91a in order to engage or release the engagement surface 110 of the dock 22 discussed in greater detail below; the first axle 92a may attached to the first actuation member 71a; the first axle 92a may extend through the left side 64 of the controller body 60, through a first sleeve 93a disposed on the controller body 60 in the depression 88 near the left side 64 of the controller body 60, and through the first hook 91a to which it is attached; and the first axle 92a may be received by a first bearing 94a disposed on the controller body 60 in the depression 88 near the left side 64 of the controller body 60.

As a second example, the second hook 91b may be attached to a second axle 92b, which may be configured to drive angular movement of the second hook 91b in order to engage or release the engagement surface 110 of the dock 22 discussed in greater detail below; the second axle 92b may attached to the second actuation member 71b; the second axle 92b may extend through the right side 65 of the controller body 60, through a second sleeve 93b disposed on the controller body 60 in the depression 88 near the right side 65 of the controller body 60, and through the second hook 91b to which it is attached; and the second axle 92b may be received by a second bearing 94b disposed on the controller body 60 in the depression 88 near the right side 65 of the controller body 60. In some embodiments, the first and second axles 92a, 92b are aligned on a lateral axis 95 spanning from the left side 64 of the controller body 60 to the right side 65 of the controller body 60.

In some embodiments, the controller 20 includes a number of controller ports 80. For example, the number of controller ports 80 may be disposed on the back side 66 of the controller body 60). As mentioned above, the dock 22 may include the number of dock ports 100. As discussed in greater detail below, each of the number of controller ports 80 may be arranged to enter into fluid engagement with a corresponding dock port of the number of dock ports 100 (and, thus, each chamber of the bladder 30 via the number of tubes 50 and the number of chamber ports 40). Depending on the implementation, the number of controller ports 80 may include six such controller ports 80, and thus include a first controller port 81, a second controller port 82, a third controller port 83, a fourth controller port 84, a fifth controller port 85, and a sixth controller port 86. Of course, it should be appreciated that the number controller ports 80 may include more (e.g., seven, eight, nine,) or less (e.g., five, four, three) controller ports.

In some embodiments, a portion of the number of controller ports 80 are positioned opposite the locking element 90 relative to another portion of the controller ports 80. For example, the first, second, third, and fourth controller ports 81, 82, 83, 84 may be positioned above (e.g., closer to the top side 62 of the controller body 60 than) the locking element 90 (or, in other words, the depression 88), while the fifth and sixth controller ports 85, 86 are positioned below (e.g., closer to the bottom side 63 of the controller body 60 than) the locking element 90 (or, in other words, the depression 88). In some embodiments, the number of controller ports 80 are positioned on an intermediate surface 89 that is vertically (e.g., between the front side 61 of the controller body 60 and the back side 66 of the controller body 60) formed between the lower surface defined by the depression 88, and the upper surface formed by the back side 66 of the controller body 60.

As mentioned above, the controller 20 may include the stand-off 96 protruding upwardly from the depression 88 adjacent to the bearing 94. In some embodiments, the controller 20 includes a first stand-off 96a protruding upwardly from the depression 88 adjacent to the first bearing 94a, and a second stand-off 96b protruding upwardly from the depression 88 adjacent to the second bearing 94b.

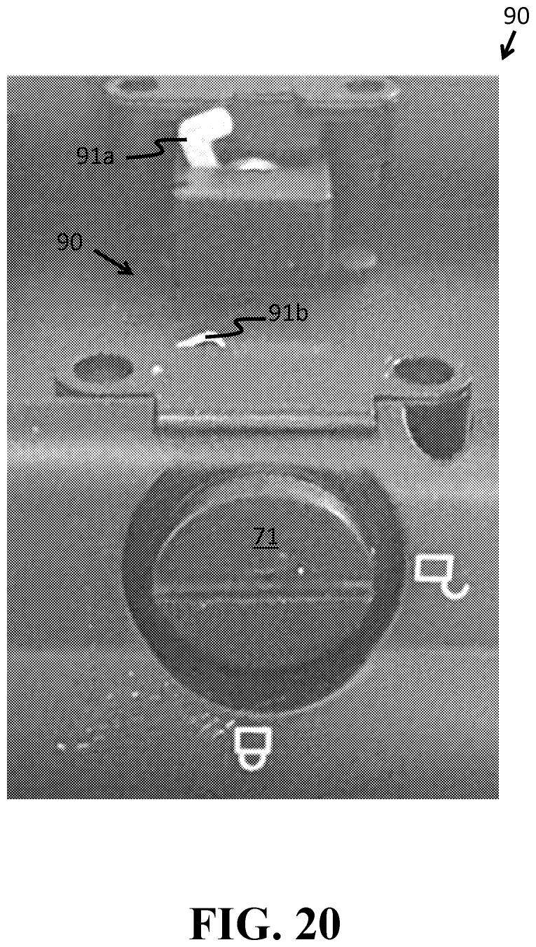

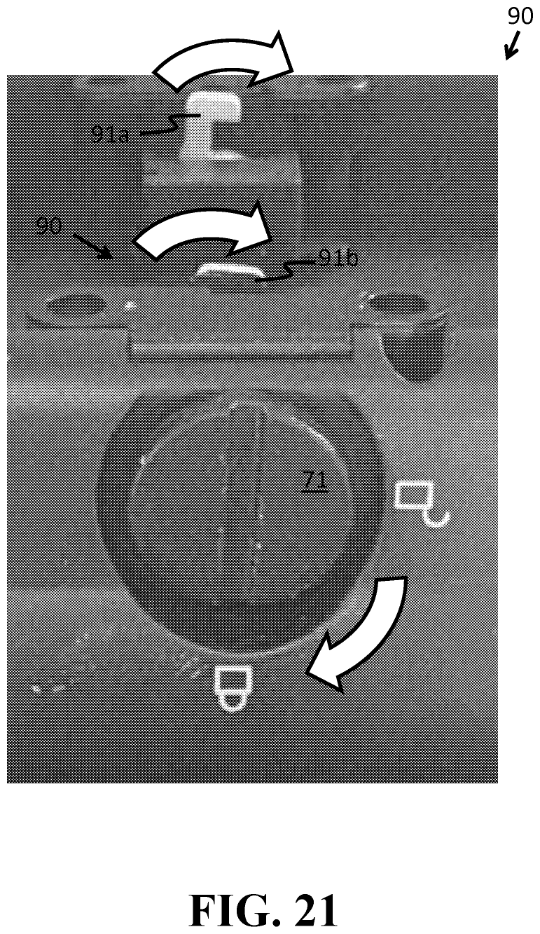

Referring now to FIGS. 20 and 21, operation of the locking element 90 is shown, according to some embodiments of the present disclosure. As discussed above and as shown, the actuation member 71 may be rotated in order to drive angular movement of the hook 91. In some embodiments, the actuation member 71 includes a slot or a key-hole, such that rotation of the actuation member 71 may be effectuated using a corresponding key.

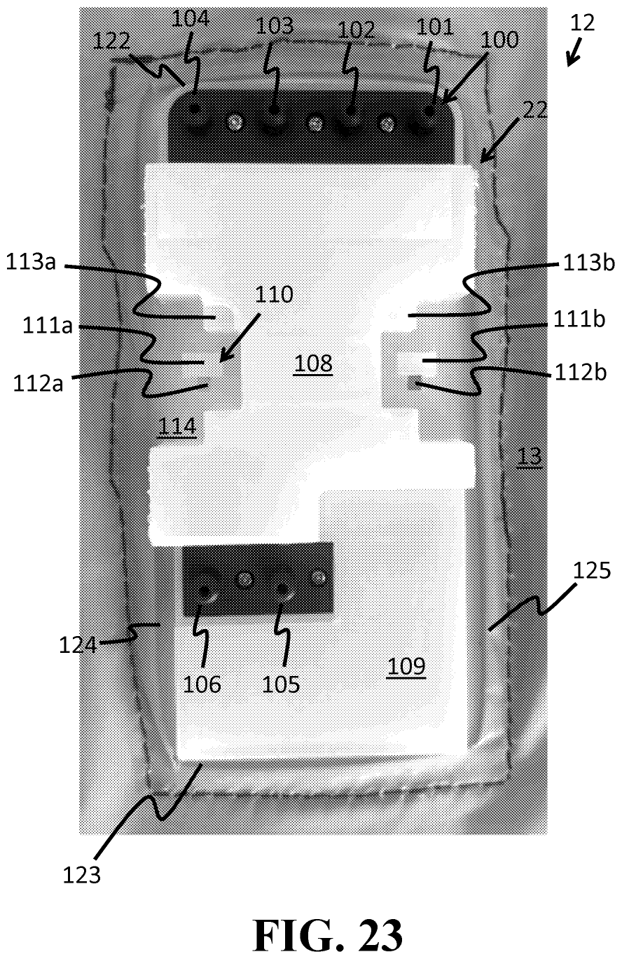

Referring now to FIGS. 22 and 23, the dock 22 is shown in greater detail, according to some embodiments of the present disclosure. As mentioned above, the dock 22 may include engagement surface 110. In some embodiments, the engagement surface 110 includes hook housing 111 adjacent to a hook opening 112. As mentioned above, the hook 91 of the controller 20 may be angularly moved in order to engage or release the engagement surface 110 of the dock 22. For example, hook 91 may be angularly moved in order to be received within the hook housing 111 and the hook opening 112 in order to engage the engagement surface 110 (in order words, the hook 91 may be angularly moved into the hook opening 112).

In some embodiments, the hook housing 111 and the hook opening 112 are positioned on a base surface 114 of the dock 22. In some embodiments, the dock 22 includes an elevated surface 108 that protrudes upwardly from the base surface 114, and a shoulder 113 that protrudes upwardly from the base surface 114 to a vertical position between the base surface 114 and the elevated surface 108.

In some embodiments, the engagement surface 110 includes a first hook housing 111a, a first hook opening 112a, a second hook housing 111b, and a second hook opening 112b. Each of the first hook housing 111a and the first hook opening 112a, and the second hook housing 111b and the second hook opening 112b, may be configured similar to the hook housing 111 and the hook opening 112 as discussed above (e.g., be configured to be receive the hook 91).

As a first example, the first hook housing 111a and the first hook opening 112a may be configured to receive the first hook 91a. As a second example, the second hook housing 111b and the second hook opening 112b may be configured to receive the second hook 91b. Accordingly, the first hook housing 111a and the first hook opening 112a may be positioned near a left side 124 of the dock 22, which may be configured to interface with the left side 64 of the controller body 60 when the controller 20 is attached to the dock 22. Similarly, the second hook housing 111b and the second hook opening 112b may be positioned near a right side 125 of the dock 22, which may be configured to interface with the right side 65 of the controller body 60 when the controller 20 is attached to the dock 22. As mentioned above, the shoulder 113 may be vertically positioned between the base surface 114 and the elevated surface 108. In some embodiments, the dock 22 includes a first shoulder 113a positioned on a left side of the elevated surface 108 near the first hook housing 111a and the first hook opening 112a, as well as a second shoulder 113b positioned on a right side of the elevated surface 108 near the second hook housing 111b and the second hook opening 112b.

As mentioned above, the controller 20 may include the depression 88 formed on the back side 63 of the controller body 60. In some embodiments, the elevated surface 108 is shaped to be inserted into depression 88 when the controller 20 is attached to the dock 22, thus facilitating alignment of the locking element 90 with the hook housing 111 and the hook opening 112. Furthermore, when the controller 20 is attached to the dock 22, the sleeve 93 may rest outside of the hook housing 111, while the bearing 94 may rest inside of the hook housing 111, thus further facilitating alignment of the locking element 90 with the hook housing 111 and the hook opening 112.

As mentioned above, the controller 20 may include the stand-off 96 protruding upwardly from the depression 88 adjacent to the bearing 94. In some embodiments, the shoulder 113 rests on the stand-off 96 when the controller 20 is attached to the dock 22, thus further facilitating alignment of the locking element 90 with the hook housing 111 and the hook opening 112. Thus, in some embodiments, the first shoulder 113a of the dock 22 is shaped to rest on the first stand-off 96a of the controller 20, and the second shoulder 113b of the dock 22 is shaped to rest on the second stand-off 96b of the controller 20.

In some embodiments, the dock 22 includes a number of dock ports 100. For example, the number of dock ports 100 may be disposed on the dock 22, facing away from the sleeve body 13, and thus be arranged to face the controller body 60 when the controller 20 is being attached to the dock 22. As mentioned above, the controller 20 may include the number of controller ports 80. As discussed in greater detail below, each of the number of dock ports 100 may be arranged to enter into fluid engagement with a corresponding controller port of the number of controller ports 80 (and, thus, the one or more pumps 140 and other internal components of the controller 20). Depending on the implementation, the number of dock ports 100 may include six such dock ports 100, and thus include a first dock port 101, a second dock port 102, a third dock port 103, a fourth dock port 104, a fifth dock port 105, and a sixth dock port 106. Of course, it should be appreciated that the number dock ports 100 may include more (e.g., seven, eight, nine,) or less (e.g., five, four, three) dock ports.

In some embodiments, a portion of the number of dock ports 100 are positioned opposite the engagement surface 110 relative to another portion of the dock ports 100. For example, the first, second, third, and fourth dock ports 101, 102, 103, 104 may be positioned above (e.g., closer to a top side 122 of the dock 22 than) the locking engagement surface 110 (or, in other words, the elevated surface 108), while the fifth and sixth dock ports 105, 106 are positioned below (e.g., closer to a bottom side 123 of the dock 22 than) the engagement surface 110 (or, in other words, the elevated surface 108). In some embodiments, the number of dock ports 100 are positioned on an intermediate elevated surface 109 that is vertically (e.g., between the base surface 114 of the dock 22 and the elevated surface 108 of the dock 22) formed between the lower surface defined by the base surface 114, and the upper surface formed by the elevated surface 108.

In some embodiments, the number of dock ports 100 engage the number of controller ports 80 in a press-fit arrangement when the controller 20 is attached to the dock 22. In some embodiments, when the controller 20 is attached to the dock 22 and the locking element 90 is angularly moved to the engaged position, the locking element 90 presses the number of controller ports 100 into the number of dock ports 80, sealing the press-fit arrangement. For example, each of the number of controller ports 80 may form a recess on a surface of the controller 20. Conversely, each of the dock ports 100 may protrude from a surface of the dock 22, forming a protrusion profile that matches a recess profile formed by each of the number of controller ports 80.

As mentioned above, the number of dock ports 100 may engage the number of controller ports 80 in a press-fit arrangement when the controller 20 is attached to the dock 22. For example, the first controller port 81 may engage the first dock port 101, the second controller port 82 may engage the second dock port 102, the third controller port 83 may engage the third dock port 103, the fourth controller port 84 may engage the fourth dock port 104, the fifth controller port 85 may engage the fifth dock port 105, and the sixth controller port 86 may engage the sixth dock port 106. Each such engagement may be a press-fit engagement. For example, such a press-fit engagement may form a fluid seal. Depending on the implementation, each of the controller ports 80 may be a hole with a layer of silicon or some other suitable deformable material lining the inner wall thereof, while each of the dock ports 100 may be a protruding post with an outer diameter at least slightly larger than the inner diameter formed by the material lining the inner wall of the controller ports 80 (and, as between the controller 20 and the dock 22, vice-versa). In further embodiments, the aforementioned protruding posts features an outer layer with such a deformable material.

Referring now to FIG. 24, internal components of the controller 20 are shown in greater detail, according to some embodiments of the present disclosure. The controller 20 may function as a fluid supply system for the bladder 30 in order to inflate the chambers of the bladder 30. In some embodiments, such inflation is sequential. In other embodiments, such inflation is simultaneous. Furthermore, the controller 20 may be used to deflate the chambers of the bladder 30. In some embodiments, such deflation is sequential. In other embodiments, such deflation is simultaneous. As discussed in greater detail below, the controller 20 may include a pump 134 including the one or more pumps 140, a valve 138, and a pressure sensor 136.

In some embodiments, the pump 134 is a pneumatic pump. In other words, the fluid provided to the bladder 30 may be air or some other compressible gas. Advantageously, by utilizing a compressible gas for applying compression therapy as discussed herein, the bladder 30 may be dimensionally inflated (e.g., inflated such that the chambers have fully expanded), but nonetheless be inflated to various internal pressures. In this sense, the compression therapy provided by the device 10 may be tailored to inflate or deflate the bladder 30 to particular pressures desirable for performing particular treatments. Conventional compression devices may inflate an internal bladder with a fluid, in some cases, and such fluids are generally incompressible, thus limiting the variance in applied pressure that may be used to treat a condition. Moreover, by utilizing compressible gas, the device 10 may not require a cumbersome source of fluid, be more appealing for portable use, and be less susceptible to wear-and-tear problems such as leaks, which may also limit the operational life of the pump in such systems.

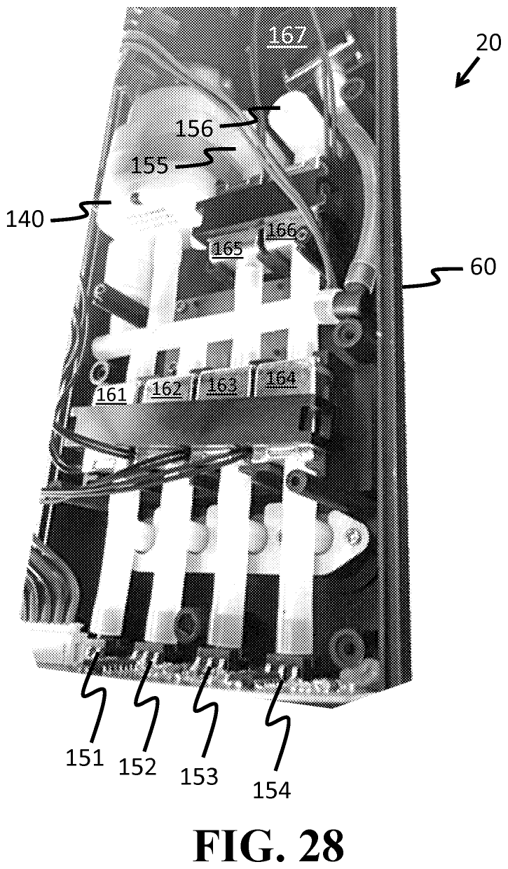

In some embodiments, the valve 138 includes one or more valves 160. In some embodiments, the valve(s) 160 includes an individual valve for each (e.g., corresponding to a respective) chamber of the bladder 30. Accordingly, in such embodiments where the bladder 30 includes six such chambers, the valve(s) 160 includes a first valve 161, a second valve 162, a third valve 163, a fourth valve 164, a fifth valve 165, and a sixth valve 166. In this sense, the device 10 may include the bladder 30 disposed on the sleeve body 13, where chambers thereof are in fluid communication with the valve(s) 160 and positioned on the sleeve body 13 in sequential order. In some embodiments, and as shown with additional reference to FIG. 28, the valve(s) 160 includes an additional seventh valve 167. The seventh valve 167 may be considered a relief valve or a deflation valve configured to release air or gas out of the controller 20. In this sense, the seventh valve 167 may be in fluid communication with each of the valve(s) 160. Furthermore, it follows that some or all of the valve(s) 60 may be one-way valves, depending on the implementation.

In some embodiments, the pump 134 includes one or more pumps 140. The valve(s) 160 mentioned above may be in fluid communication with the pump(s) 140. In some embodiments, the pump(s) 140 includes an individual pump for each chamber of the bladder 30. In this sense, the pump(s) 140 may include a number (e.g., two or more) of pumps 140. Accordingly, in such embodiments where the bladder 30 includes six such chambers, the pump(s) 140 may include a first pump 141, a second pump 142, a third pump 143, a fourth pump 144, a fifth pump 145, and a sixth pump 146.

Each of the pump(s) 140 may be in fluid communication with a corresponding controller port of the number of controller ports 80 via a corresponding valve of the valve(s) 160, thus fluidly coupling the pump(s) 140 to the valve(s) 160 and the number of tubes 50 depicted with reference to FIG. 11.

As a first example, the first fluid pump 141 may be fluidly coupled to the first tube 51 via the first valve 161, which may be fluidly coupled to the first controller port 81, and thus the first dock port 101 (when the controller 20 is attached to the dock 22), which in turn is coupled to the first tube 51, which in turn is coupled to the first chamber port 41 of the first chamber 31.

As a second example, the second fluid pump 142 may be fluidly coupled to the second tube 52 via the second valve 162, which may be fluidly coupled to the second controller port 82, and thus the second dock port 102 (when the controller 20 is attached to the dock 22), which in turn is coupled to the second tube 52, which in turn is coupled to the second chamber port 42 of the second chamber 32.

As a third example, the third fluid pump 143 may be fluidly coupled to the third tube 53 via the third valve 163, which may be fluidly coupled to a third controller port 83, and thus the third dock port 103 (when the controller 20 is attached to the dock 22), which in turn is coupled to the third tube 53, which in turn is coupled to the third chamber port 43 of the third chamber 33.

As a fourth example, the fourth fluid pump 144 may be fluidly coupled to the fourth tube 54 via the fourth valve 164, which may be fluidly coupled to the fourth controller port 84, and thus the fourth dock port 104 (when the controller 20 is attached to the dock 22), which in turn is coupled to the fourth tube 54, which in turn is coupled to the fourth chamber port 44 of the fourth chamber 34.

As a fifth example, the fifth fluid pump 145 may be fluidly coupled to the fifth tube 55 via the fifth valve 165, which may be fluidly coupled to the fifth controller port 85, and thus the fifth dock port 105 (when the controller 20 is attached to the dock 22), which in turn is coupled to the fifth tube 55, which in turn is coupled to the fifth chamber port 45 of the fifth chamber 35.

As a sixth example, the sixth fluid pump 146 may be fluidly coupled to the sixth tube 56 via the sixth valve 166, which may be fluidly coupled to the sixth controller port 86, and thus the sixth dock port 106 (when the controller 20 is attached to the dock 22), which in turn is coupled to the sixth tube 56, which in turn is coupled top the sixth chamber port 46 of the sixth chamber 36.

As mentioned above, the controller 20 may include the pressure sensor 136. For example, the pressure sensor 136 may be disposed on the controller body 60. The controller 20 may be configured to provide selective activation and deactivation of each of the pump(s) 140. Additionally, the controller 20 may be configured to provide selective opening and closing of each of the valve(s) 160. Depending on the implementation, such selective control may be at least partially based on pressure signals received from the pressure sensor 136. The pressure sensor 136 may be configured to detect a fluid pressure within each of chamber of the bladder 30.

In some embodiments, the pressure sensor 136 includes one or more pressure sensors 150. In some embodiments, the pressure sensor(s) 150 includes an individual pressure sensor for each chamber of the bladder 30. Accordingly, in such embodiments where the bladder 30 includes six such chambers, the pressure sensor(s) 150 includes a first fluid pressure sensor 151, a second fluid pressure sensor 152, a third fluid pressure sensor 153, a fourth fluid pressure sensor 154, a fifth fluid pressure sensor 155, and a sixth fluid pressure sensor 156. Thus, the device 10 may include the pressure sensor(s) 150, which may be configured to transmit a number of pressure signals. In particular, the pressure sensor(s) 150 may be configured to detect a fluid pressure within each chamber of the bladder 30 and transmit a pressure signal of the number of pressure signals, where each of the pressure signals may indicate the detected fluid pressure within a corresponding chamber of the bladder 30. In turn, the processor 130 of the controller 20 may be configured to control activation of the pump(s) 140 based at least in part on pressure signals received from the pressure sensor(s) 150.

As mentioned above, the processor 130 of the controller 20 may be able to provide selective control over components of the device 10 based on the aforementioned pressure signals. Accordingly, the processor 130 may be in electrical communication with the valve(s) 160 and the pump(s) 140. The processor 130 may be configured to receive the pressure signals from the pressure sensor 136 and, based on the pressure signals, control the opening and closing of the valve(s) 160 and the activation and deactivation of the pump(s) 140 in order to direct the inflation of the bladder 30. As mentioned above, the controller 20 may include the user interface 67, which may be used to receive user inputs to initiate a treatment process or select various operational settings associated with performance of the device 10 as discussed herein.

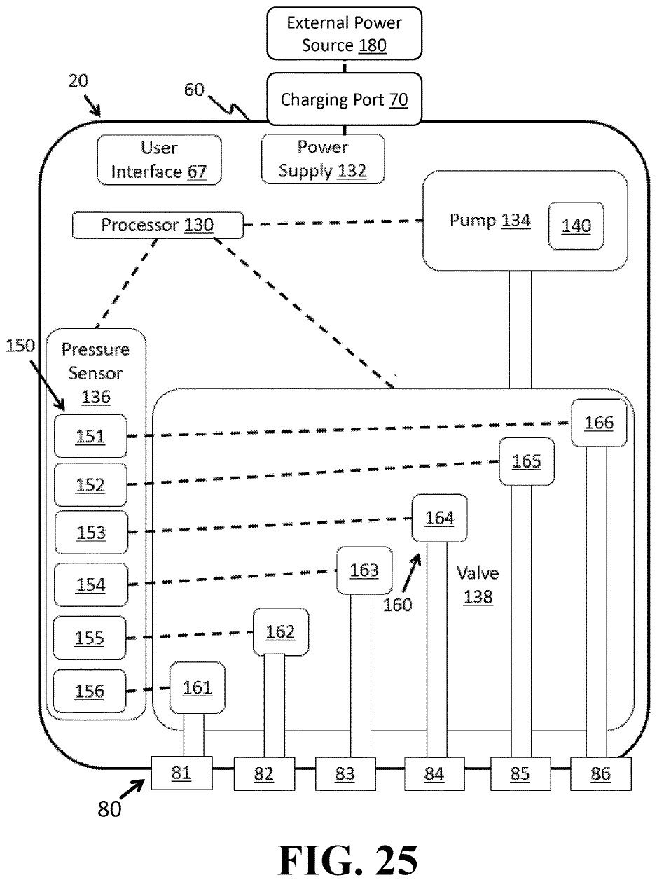

Referring now to FIG. 25, components of the controller 20 are shown, according to other embodiments of the present disclosure. As mentioned above, the pump 134 may include the pump(s) 140, which may include an individual pump for each chamber of the bladder 30. In other embodiments, and as shown, the pump(s) 140 include a single pump 140, which is in fluid communication with each of the valve(s) 160. In other words, the aforementioned single pump 140 may be in fluid communication with the valve(s) 160 such that opening a selected valve of the valve(s) 160 directs gas from the single pump 140 to the chamber of the bladder 30 corresponding to such selected valve. When one of the chambers of the bladder 30 is being inflated, the applicable valve 160 may be open, while the other valve(s) 160 are closed. Thus, a single pump 140 may be turned on and off to inflate each chamber of the bladder 30, and the open valve among the valve(s) 160 may be sequentially cycled trough the valve(s) 160 in order to divert the fluid supply provided by the single pump 140 into each chamber of the bladder 30. Thus, the pump(s) 140 may include a single pump in fluid communication with each of the valve(s) 160. In other embodiments, one or more of the valve(s) 160 may be open simultaneously in order to effectuate simultaneous inflation of one or more chambers of the bladder 30. In some cases, the valve(s) 160 may be opened simultaneously, but closed in a sequential fashion, in order to effectuate graduated compression therapy.

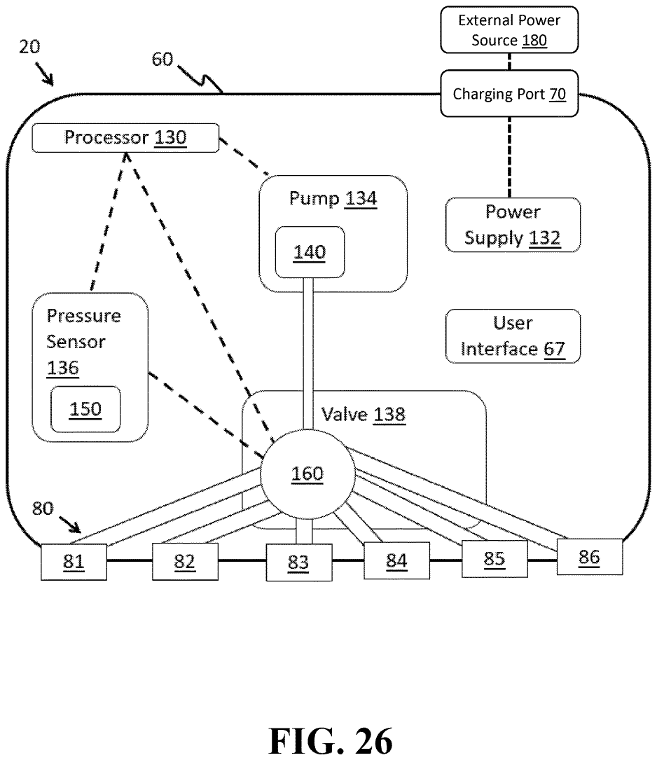

Referring now to FIG. 26, components of the controller 20 are shown, according to further embodiments of the present disclosure. As mentioned above, the pump 134 may include the valve(s) 160, which may include an individual valve for each chamber of the bladder 30. In other embodiments, and as shown, the valve(s) 160 include a single valve 160, which may accept a fluid supply from a single source (e.g., the single fluid pump 140 as discussed above with reference to FIG. 25), and divert the fluid supply to a number of different output channels (e.g., the various different fluid supply ports 56) based on a communication from the processor 130. As an example, the single valve 160 may be a multi-chamber solenoid valve. As another example, the single valve 160 may be a multi-chamber servo valve. Accordingly, the valve(s) 160 may include a single valve, where the single valve is in fluid communication with each chamber of the bladder 30.

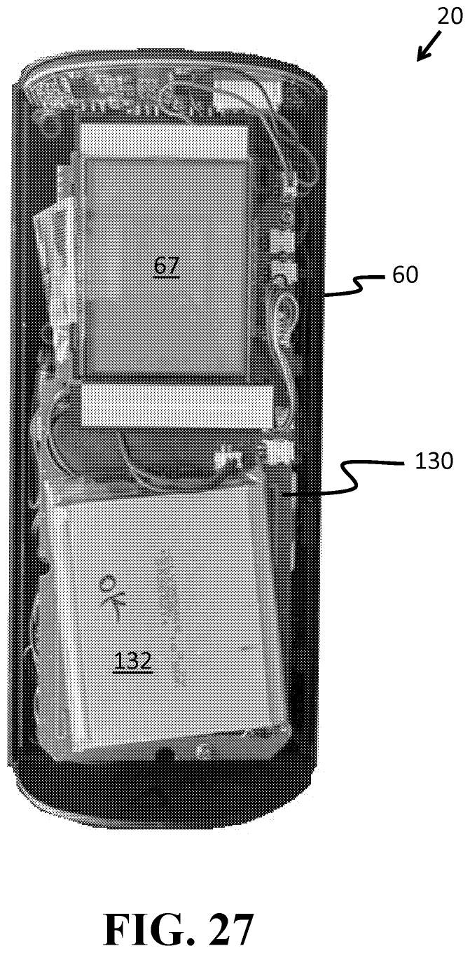

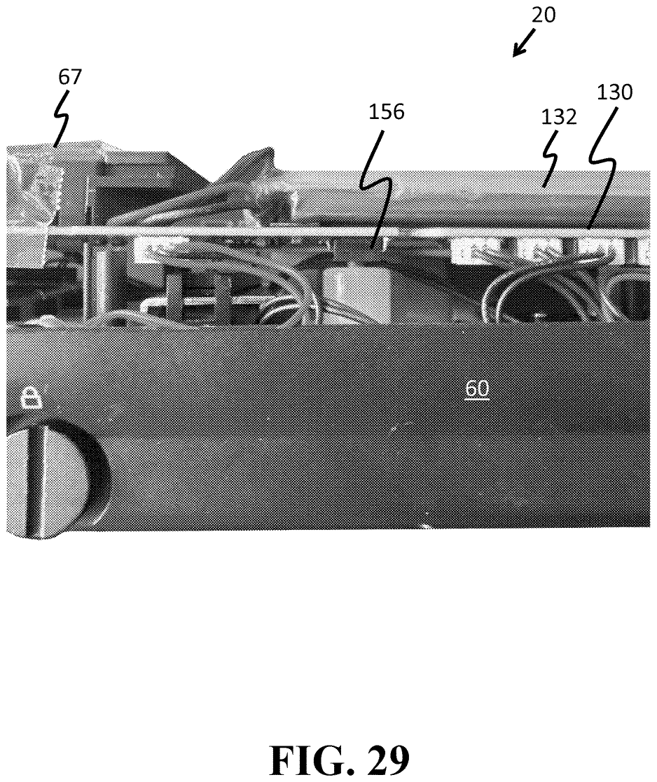

Referring now to FIGS. 27-29, an exemplary implementation of the internal components of the controller 20 is shown, according to some embodiments of the present disclosure. As mentioned above, the pump(s) 140 may include the single pump 140, which may be in fluid communication with each of the valve(s) 160.

As mentioned above, the valve(s) 160 may include the first valve 161, the second valve 162, the third valve 163, the fourth valve 164, the fifth valve 165, and the sixth valve 166, each in fluid communication with the single pump 140. In this sense, the device 10 may include the bladder 30 disposed on the sleeve body 13, where the chambers of the bladder 30 are in fluid communication with the valve(s) 160 and positioned on the sleeve body 13 in sequential order.

As mentioned above, the pressure sensor(s) 150 may include the first fluid pressure sensor 151, the second fluid pressure sensor 152, the third fluid pressure sensor 153, the fourth fluid pressure sensor 154, the fifth fluid pressure sensor 155, and the sixth fluid pressure sensor 156.

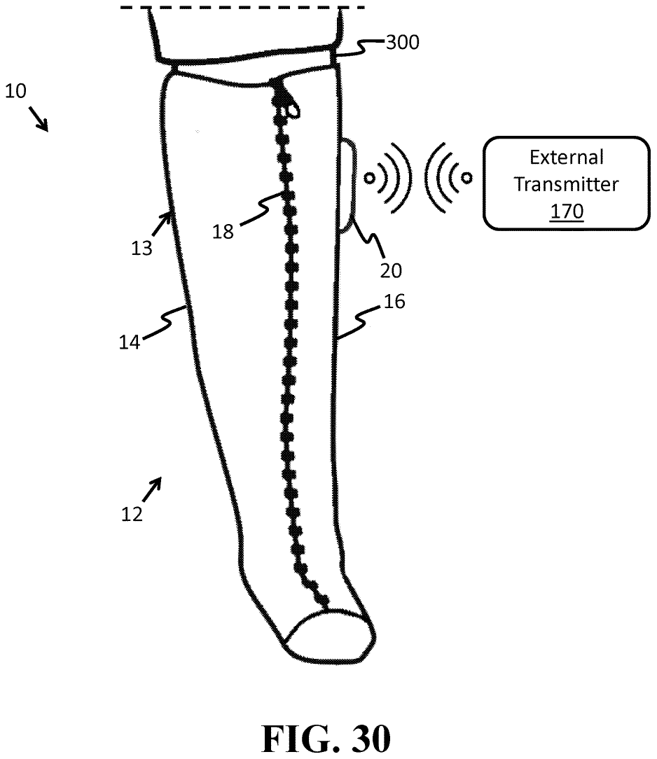

Referring now to FIG. 30, the device 10 is shown, according to other embodiments of the present disclosure. In some embodiments, the controller 20 (or, more particularly, the processor 130) is configured to communicate wirelessly with an external transmitter 170. The external transmitter 170 may be configured to transmit various data packets to the processor 130 in order to carry out the various processes described herein. Accordingly, the controller 20 may be configured to communicate wirelessly with the external transmitter 170 to receive at least one control input that customizes at least one operating setting of the device 10 discussed herein.

In accordance with discussion of the device 10 herein, the present disclosure further provides for a method of compressing a limb, such as the leg 300. The method may include providing the sleeve 12 and removably attaching the aforementioned controller 20 to the dock 22 of the sleeve 12 (e.g., positioning a battery-powered controller on the dock 22). The method may further include angularly moving the locking element 90 of the controller 20 from the released position to the engaged position where the locking element 90 engages the engagement surface 110 of the dock 22. The method may further include at least partially surrounding a limb with the sleeve body 13. The method may further include activating the one or more pumps 140 of the controller 20, such that at least one chamber of the bladder 30 of the sleeve 12 is inflated. In some embodiments, the method further includes angularly moving the locking element 90 from the engaged position to the released position, such that the locking element 90 disengages the engagement surface 110. Thus, the method may further include separating the controller 20 from the sleeve 12. In some embodiments, the method further includes connecting the charging port 70 to the external power source 180 in order to re-charge the power supply 132.

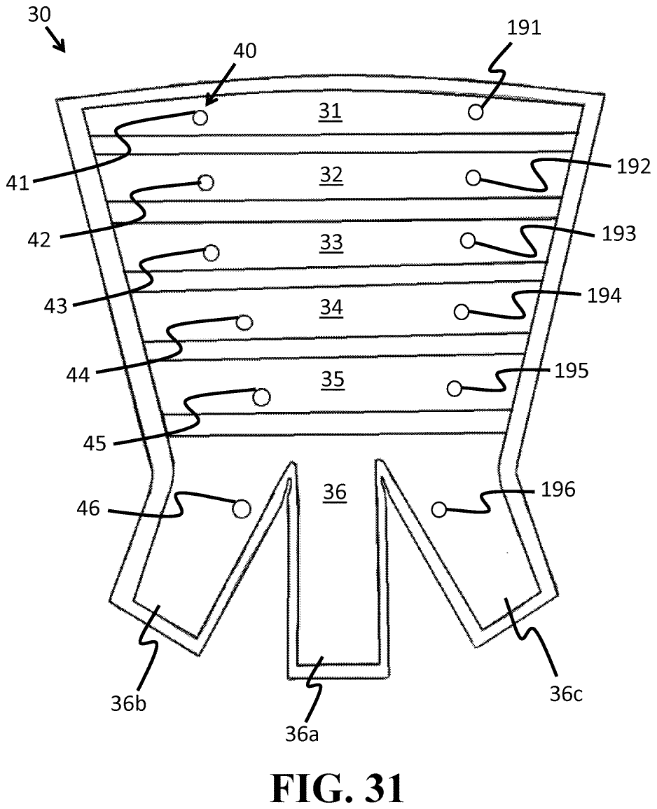

Referring now to FIG. 31, the bladder 30 is shown, according to further embodiments of the present disclosure. As mentioned above, the sleeve 12 may include the number of chamber ports 40 each disposed on and in fluid communication with a corresponding chamber of the bladder 30. In some embodiments, the number of chamber ports 40 includes the first, second, third, fourth, fifth, and sixth chamber ports 41, 42, 43, 44, 45, 46, as mentioned above. In further embodiments, the number of chamber ports 40 may further include a seventh chamber port 191 disposed on and in fluid communication with the first chamber 31; an eight chamber port 192 disposed on and in fluid communication with the second chamber 32; a ninth chamber port 193 disposed on and in fluid communication with the third chamber 33; a tenth chamber port 194 disposed on and in fluid communication with the fourth chamber 34; an eleventh chamber port 195 disposed on and in fluid communication with the fifth chamber 35; and a twelfth chamber port 196 disposed on and in fluid communication with the sixth chamber 36.

Depending on the implementation, a portion of the chamber ports 40 (e.g., the first, second, third, fourth, fifth, and sixth chamber ports 41, 42, 43, 44, 45, 46) may be considered inflow ports configured to receive a fluid for inflation of the corresponding inflatable bladder 30, while a different portion of the chamber ports 40 (e.g., the seventh, eighth, ninth, tenth, eleventh, and twelfth chamber ports 191, 192, 193, 194, 195, 196) may be considered sensor ports. In this sense, for each chamber, the chamber ports 40 may include an inflow port configured to receive gas for inflation and a sensor port configured to place a pressure sensor (e.g., one of the pressure sensor(s) 150) in fluid communication with the inflatable chamber.

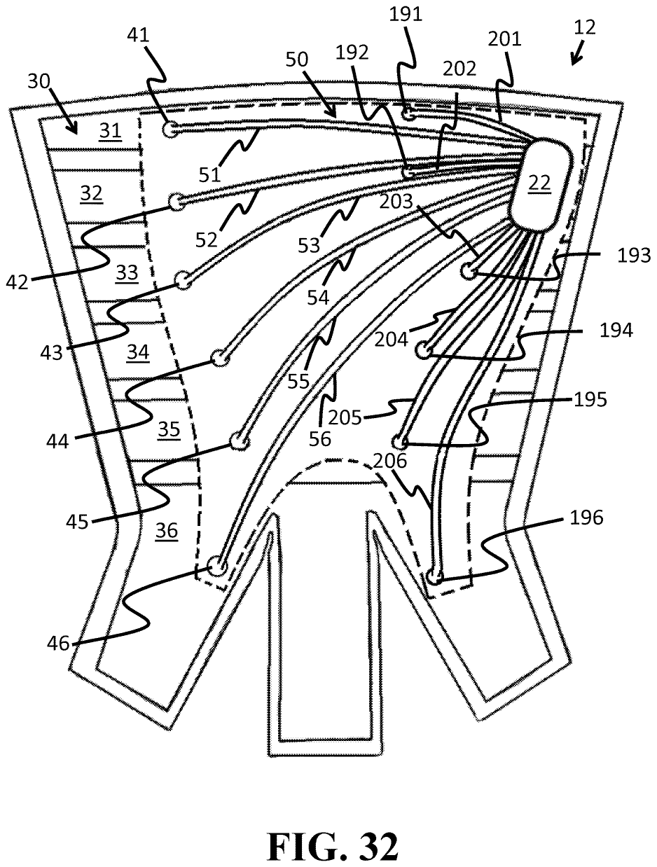

Referring now to FIG. 32, the bladder 30 is shown in fluid communication with the dock 22, according to further embodiments of the present disclosure. As mentioned above, the sleeve 12 may further include the number of tubes 50, which may include the first, second, third, fourth, fifth, and sixth tubes 51, 52, 53, 54, 55, 56. In further embodiments, the number of tubes 50 may further include a seventh tube 201 disposed on and fluidly coupling the seventh chamber port 191 to the dock 22; an eighth tube 202 disposed on and fluidly coupling the eighth chamber port 192 to the dock 22; a ninth tube 203 disposed on and fluidly coupling the ninth chamber port 193 to the dock 22; a tenth tube 204 disposed on and fluidly coupling the tenth chamber port 194 to the dock 22; an eleventh tube 205 disposed on and fluidly coupling the eleventh chamber port 195 to the dock 22; and a twelfth tube 206 disposed on and fluidly coupling the twelfth chamber port 196 to the dock 22.

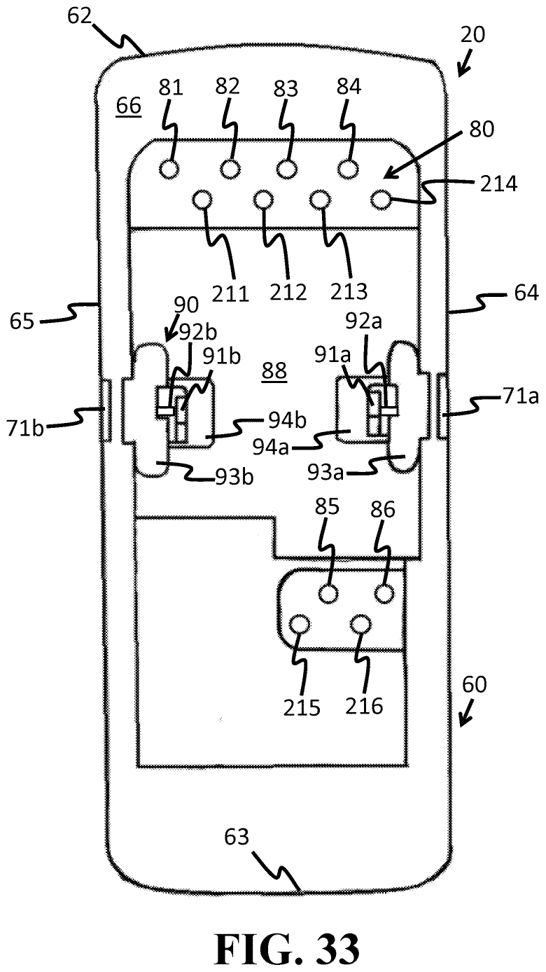

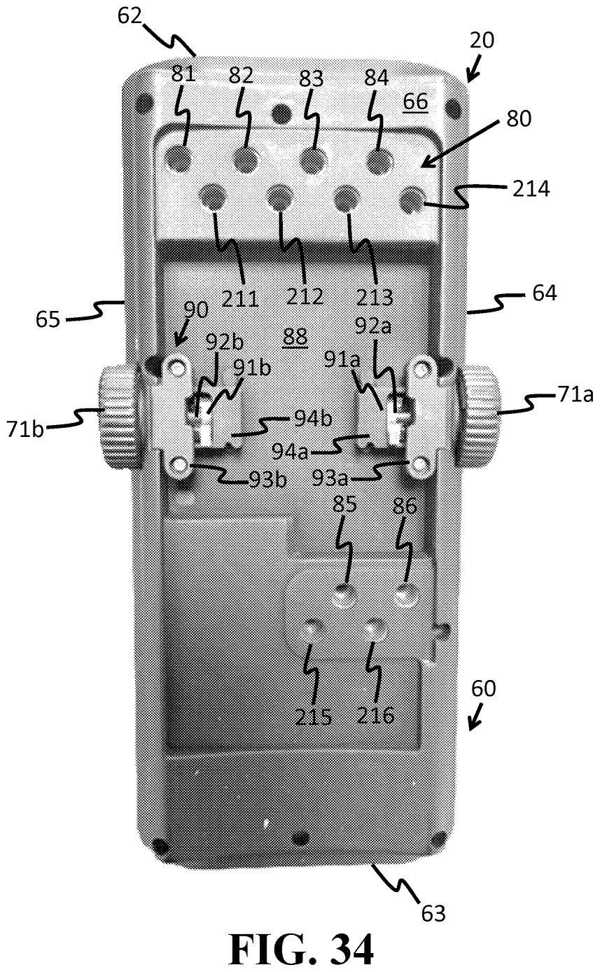

Referring now to FIGS. 33 and 34, the back side 66 of the controller 20 is shown, according to further embodiments of the present disclosure. As mentioned above, the number of controller ports 80 may be disposed on the controller 20. In some embodiments, the number of controller ports 80 includes the first, second, third, fourth, fifth, and sixth controller ports 81, 82, 83, 84, 85, 86. In further embodiments, the number of controller ports 80 further includes a seventh controller port 211, an eight controller port 212, a ninth controller port 213, a tenth controller port 214, an eleventh controller port 215, and a twelfth controller port 216. Depending on the implementation, the seventh, eighth, ninth, and tenth controller ports 211, 212, 213, 214 may be positioned above (e.g., closer to the top side 62 of the controller body 60 than) the locking element 90 (or, in other words, the depression 80), while the eleventh and twelfth controller ports 215, 216 are positioned below (e.g., closer to the bottom side 63 of the controller body 60 than) the locking element 90 (or, in other words, the depression 88).

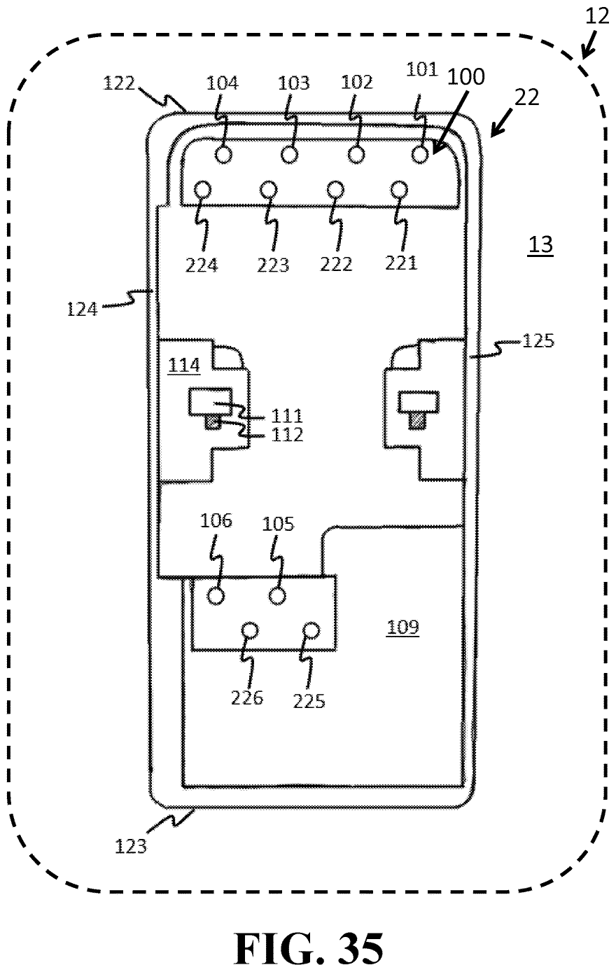

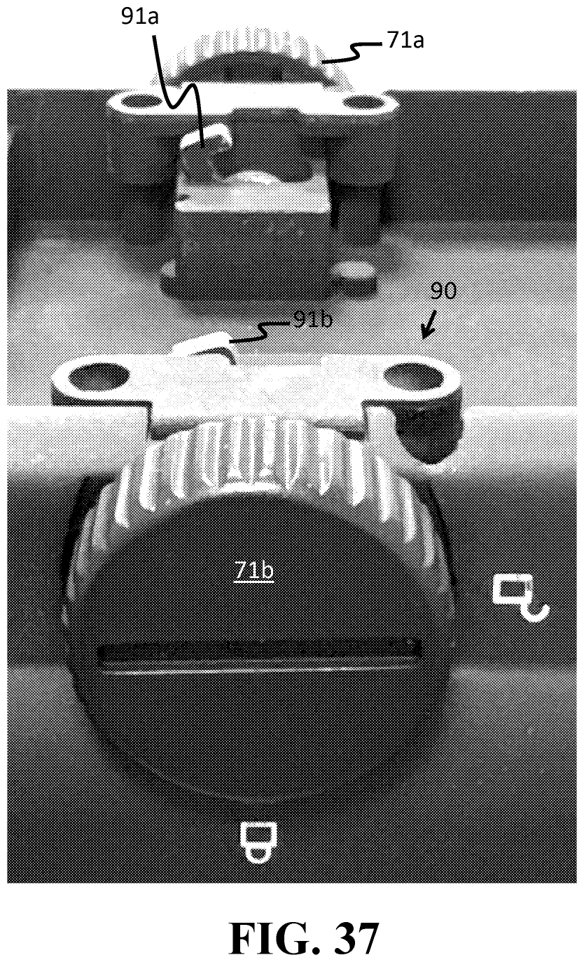

Referring now to FIGS. 35-37, the dock 22 is shown, according to further embodiments of the present disclosure. As mentioned above, the number of dock ports 100 may be disposed on the dock 22. In some embodiments, the number of dock ports includes the first, second, third, fourth, fifth, and sixth dock ports 101, 102, 103, 104, 105, 106. In further embodiments, the number of dock ports 100 further includes a seventh dock port 221, an eight dock port 222, a ninth dock port 223, a tenth dock port 224, an eleventh dock port 225, and a twelfth dock port 226. Depending on the implementation, the seventh, eight, ninth, and tenth dock ports 221, 222, 223, 224 may be positioned above (e.g., closer to a top side 122 of the dock 22 than) the locking engagement surface 110 (or, in other words, the elevated surface 108), while the eleventh and twelfth dock ports 225, 226 are positioned below (e.g., closer to a bottom side 123 of the dock 22 than) the engagement surface 110 (or, in other words, the elevated surface 108).

As mentioned above, the number of dock ports 100 may engage the number of controller ports 80 in a press-fit arrangement when the controller 20 is attached to the dock 22. For example, the seventh controller port 211 may engage the seventh dock port 221, the eighth controller port 212 may engage the eighth dock port 222, the ninth controller port 213 may engage the ninth dock port 223, the tenth controller port 214 may engage the tenth dock port 224, the eleventh controller port 215 may engage the eleventh dock port 225, and the twelfth controller port 216 may engage the twelfth dock port 226. As discussed above, each such engagement may be a press-fit engagement. For example, the locking element 90, when in the engaged position, may apply a compressive force that urges the controller ports 80 into sealing engagement with the number of dock ports 100 to seal the aforementioned press-fit arrangement.

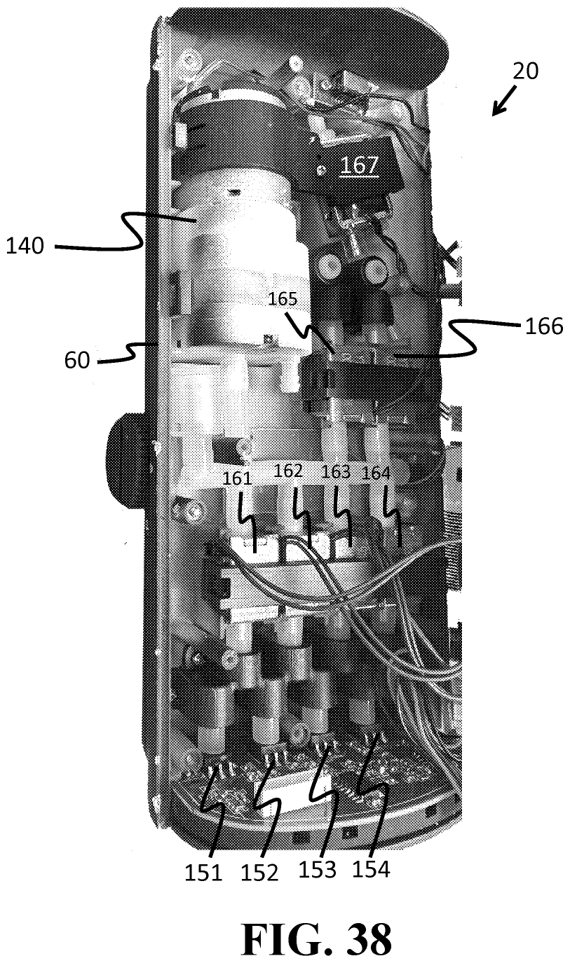

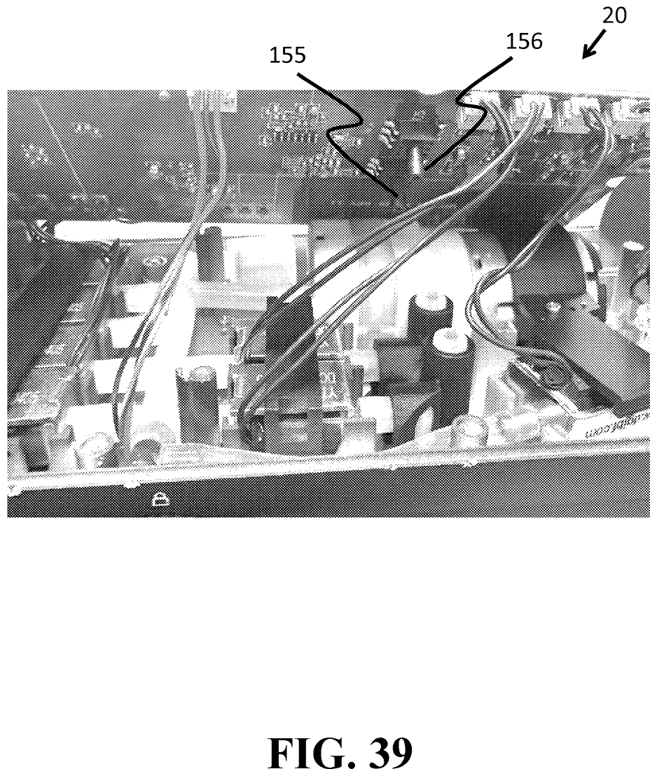

Referring now to FIGS. 38-40, internal components of the controller 20 are shown, according to further embodiments of the present disclosure. As mentioned above, the pressure sensor 136 may include the one or more pressure sensors 150, which may include the first, second, third, fourth, fifth, and sixth pressure sensors 151, 152, 153, 154, 155, 156. Depending on the implementation, when the controller 20 is attached to the dock 22, the seventh, eighth, ninth, tenth, eleventh, and twelfth dock ports 221, 222, 223, 224, 225, 226 place the one or more pressure sensors 150 in fluid communication with the chambers of the bladder 30. In this sense, the dock 22 may include a first set of the dock ports 100 corresponding to the chamber ports 40 configured as inflow ports, and a second set of the dock ports 100 corresponding to the chamber ports 40 configured as sensor ports. Similarly, the controller 20 may include a first set of the controller ports 80 corresponding to the aforementioned first set of the dock ports 100, and a second set of controller ports 80 corresponding to the aforementioned second set of the dock ports 100.

As a first example, the first pressure sensor 151 may be fluidly coupled to the first tube 51 via the first valve 161, which may be fluidly coupled to the first controller port 81, and thus the first dock port 101 (when the controller 20 is attached to the dock 22), which in turn is coupled to the first tube 51, which in turn is coupled to the first chamber port 41 of the first chamber 31

As a first example, the first pressure sensor 151 may be fluidly coupled to the seventh controller port 211, which may be fluidly coupled to the seventh tube 201 via the first seventh dock port 221, and the seventh tube 201 may be fluidly coupled to the first chamber 31 via the seventh chamber port 191.

As a second example, the second pressure sensor 152 may be fluidly coupled to the eighth controller port 212, which may be fluidly coupled to the eighth tube 202 via the eighth dock port 222, and the eighth tube 202 may be fluidly coupled to the second chamber 32 via the eighth chamber port 192.

As a third example, the third pressure sensor 153 may be fluidly coupled to the ninth controller port 213, which may be fluidly coupled to the ninth tube 203 via the ninth dock port 223, and the ninth tube 203 may be fluidly coupled to the third chamber 33 via the ninth chamber port 193.

As a fourth example, the fourth pressure sensor 154 may be fluidly coupled to the tenth controller port 214, which may be fluidly coupled to the tenth tube 204 via the tenth dock port 224, and the tenth tube 204 may be fluidly coupled to the fourth chamber 34 via the tenth chamber port 194.

As a fifth example, the fifth pressure sensor 155 may be fluidly coupled to the eleventh controller port 215, which may be fluidly coupled to the eleventh tube 205 via the eleventh dock port 225, and the eleventh tube 205 may be fluidly coupled to the fifth chamber 35 via the eleventh chamber port 195.

As a sixth example, the sixth pressure sensor 156 may be fluidly coupled to the twelfth controller port 216, which may be fluidly coupled to the twelfth tube 206 via the twelfth dock port 226, and the twelfth tube 206 may be fluidly coupled to the sixth chamber 36 via the twelfth chamber port 196.

In some embodiments, the controller 20 includes an indication speaker 230. For example, the indication speaker 230 may generate one or more audio signals (e.g., beeps) when the controller 20 is attached to the dock 22. As mentioned above, each of the first and second actuation members 71a, 71b in order to drive angular movement of the corresponding first and second hooks 91a, 91b, thus securing the first and second hooks 91a, 91b in the corresponding hook holes 112a, 112b, thus securing the controller 20 to the dock 22. In some embodiments, when either of the actuation members 71a, 71b are rotated in order to insert the first and second hooks 91a, 91b into place as discussed above, the indication speaker 230 may generate an audio signal. In this sense, the processor 130 may be configured to detect an angular position of each of the first and second axles 92a, 92b, in order to determine their position and instruct the indication speaker 230 accordingly. In this sense, the controller 20 may include the first and second actuation members 71a, 71b on opposing sides of the controller body 60, which may be coupled to the first and second hooks 91a, 91b (respectively), such that rotation of the first and second actuation members 71a, 71b angularly moves the first and second hooks 91a, 91b between the released position and engaged position.

As mentioned above, the present disclosure further provides for a method of compressing a limb, such as the leg 300, which may include activating the one or more pumps 140 of the controller 20, such that at least one chamber of the bladder 30 of the sleeve 12 are inflated. As mentioned above, such inflation may be sequential or simultaneous. Depending on the implementation, each chamber of bladder 30 may be inflated to a particular pressure, which may be detected by the pressure sensor 136, at which point the processor 130 may deactivate the applicable pump(s) 141 and, immediately or at a later time, open the applicable valve(s) 161 in order to begin deflation of the applicable inflatable bladder 30. In some embodiments, such pressure is pre-set, or may be selected from a set number of pressures via the user interface 67 of the controller 20. In other embodiments, such pressure may be based on a specific numeric input provided to the user interface 167 of the controller 20 by the user. In some embodiments, such pre-set, selected, or input pressure is the same for each of the chambers of the bladder 30. In other embodiments, some or all of the chambers of the bladder 30 may be inflated to a unique pressure in the fashion (pre-set, selected, or input) discussed above.

As mentioned above, one or more of the chambers of the bladder 30 may be inflated to a particular pressure. As non-limiting examples, one or more of the chambers of the bladder 30 may be inflated to a working pressure of 20 mmHg, 30 mmHg, 40 mmHg, 50 mmHg, 60 mmHg, 70 mmHg, 80 mmHg, etc.

In some embodiments, the controller 20 may be configured to inflate the chambers of the bladder 30 to a working pressure of 40 mmHg as a default setting, while a user may operate the controller 20 to select other pressures to which the chambers are inflated. In some embodiments, the controller 20 may be configured to allow a user to perform a “calibration” function (e.g., a calibration cycle), whereby they select amongst various pressures (such as the aforementioned range) and, upon selection, the controller 20 dictates inflation of each chamber of the bladder 30 to such pressure before deflating. The user may repeat this process for any number of selected pressures, before identifying one pressure as the new default pressure (e.g., 60 mmHg). In other words, the calibration function may include performing a calibration function in which a selected working pressure is applied by inflating each chamber of the bladder 30 to the selected working pressure and thereafter deflating the chambers of the bladder 30. In turn, under standard operating functions, the controller 20 may dictate inflation of the chambers of the bladder 30 to this new default pressure.

As mentioned above, the controller 20 may be configured to dictate inflation at various operating modes. For instance, depending on the implementation, the controller may be set to operate in a “normal mode,” whereby the chambers of the bladder 30 may be sequentially inflated. For instance in the “normal mode,” the controller 20 may sequentially inflate the chambers of the bladder 30 in a first-to-last chamber-inflation order and thereafter deflate the chambers. In some embodiments, the aforementioned first-to-last chamber-inflation order includes inflating the first chamber 31, then the second chamber 32, then the third chamber 33, then the fourth chamber 34, then the fifth chamber 35, then the sixth chamber 36. In some embodiments, the aforementioned last-to-first chamber-inflation order includes inflating the sixth chamber 36, then the fifth chamber 35, then the fourth chamber 34, then the third chamber 33, then the second chamber 32, then the first chamber 31.

Of course, in other embodiments, such inflation may be simultaneous. As described in greater detail below, the controller 20 may be further configured to dictate inflation in a “clearing mode.” For instance in the “clearing mode,” the controller 20 may alternate the aforementioned chamber-inflation order between the first-to-last chamber inflation order mentioned above and a second, different chamber-inflation order that includes a last-to-first chamber-inflation order. Further, in the “clearing mode,” the controller 20 may alternate the chamber-inflation order between the first chamber inflation order (e.g., first-to-last) and the second chamber inflation order (e.g., last-to-first) across successive compression cycles. Accordingly, the processor 130 may include processor circuitry and a data storage storing instructions that, when executed, cause the controller 20 to operate in at least a “normal mode” and a “clearing mode.”

As an example of sequential inflation, the first chamber 31 of the bladder 30 may be inflated from a working pressure of 0 mmHg to a working pressure of 40 mmHg (or a different set pressure as mentioned above); then the second chamber 32 of the bladder 30 may be inflated from a working pressure of 0 mmHg to a working pressure of 40 mmHg (or the other set pressure); then the third chamber 33 of the bladder 30 may be inflated from a working pressure of 0 mmHg to a working pressure of 40 mmHg (or the other set pressure); then the fourth chamber 34 of the bladder 30 may be inflated from a working pressure of 0 mmHg to a working pressure of 40 mmHg (or the other set pressure); then the fifth chamber 35 of the bladder 30 may be inflated from a working pressure of 0 mmHg to a working pressure of 40 mmHg (or the other set pressure); then the sixth chamber 36 of the bladder 30 may be inflated from a working pressure of 0 mmHg to a working pressure of 40 mmHg (or the other set pressure). After such sequential impression, each such chamber of the bladder 30 may then remain inflated for a pre-determined period of time (e.g., 10 seconds).

Depending on the implementation, each such chamber of the bladder 30 may then be allowed to simultaneously (or, in other embodiments, sequentially) deflate. After such deflation, each such chamber of the bladder 30 may remain deflated for a period time (e.g., 30 seconds), before the aforementioned process of inflation is repeated. In turn, the aforementioned sequence of inflation and deflation may be repeated for a pre-determined amount of times (e.g., two, three, four, ten, twenty, etc.).

As mentioned above, after each chamber of the bladder 30 has been inflated to a set pressure, each such chamber of the bladder 30 may be deflated. In some embodiments, each inflatable bladder 30 may remain inflated at the set pressure for a specific period of time before deflation is activated by the processor 130. Depending on the implementation, the specific period of time before deflation is activated by the processor 130 is pre-set, selected, or input by the user, in a fashion similar to the setting of the applicable pressure as discussed above.

As mentioned above, the controller 20 may be configured to dictate inflation of the chambers of the bladder 30 in a “normal mode.” In some embodiments, a user may operate the controller 20 to select between functionality of the aforementioned “normal mode,” or additional modes, such as the aforementioned “clearing mode.” As described in greater detail below, in the “clearing mode” the controller 20 may sequentially inflate the inflatable chambers in a first chamber-inflation order during a first compression cycle and sequentially inflate the inflatable chambers in a second, different chamber-inflation order during a subsequent compression cycle.

For instance, in the aforementioned cadence of a “normal mode” operation, each chamber of the bladder 30 may be sequentially inflated (first, second, third, fourth, fifth, sixth), then deflated, and such sequential inflation may be repeated in the same cadence (first, second, third, fourth, fifth, sixth). In an alternative “clearing mode,” for example, each chamber of the bladder 30 may be sequentially inflated (first, second, third, fourth, fifth, sixth), then deflated, and such sequential inflation may be repeated in a reverse cadence relative to the prior cadence of inflation (sixth, fifth, fourth, third, second, first). Of course, such an inflation sequence may be repeated once again, in which case the cadence may again be reversed (first, second, third, fourth, fifth, sixth). Of course, in further embodiments, all of the cadences may be reversed from the outset. For instance, further embodiments of a “normal mode,” the sequential inflation is on a declining cadence (sixth, fifth, fourth, third, second, first) each time, and in further embodiments of a “clearing mode,” the first sequential inflation is on such a declining cadence, before such cadence is reversed as mentioned above.

In accordance with the discussion above, the aforementioned method of compressing a limb may include selecting a treatment mode from a number of treatment modes, the number of treatment modes including the aforementioned “normal mode” and the aforementioned “clearing mode.” In some embodiments, selecting the treatment mode includes selecting the “clearing mode,” where in the “clearing mode,” the controller 20 sequentially inflates the chambers of the bladder 30 in a first chamber-inflation order during a first compression cycle and sequentially inflates the chambers in a second, different chamber-inflation order during a subsequent compression cycle. Thus, the controller 20 may alternate the chamber-inflation order between the first chamber-inflation order and the second chamber-inflation order across successive compression cycles. In some embodiments, the method further includes permitting initiation of the selected treatment mode only when a rotational sensor indicates that the locking element 90 is in the engaged position discussed above.

In some embodiments, the method further includes performing the calibration function discussed above, and thus setting a selected working pressure as a default working pressure for subsequent treatment sessions.

In some embodiments, the controller 20 is configured to provide a low pressure or leak alarm. For example, if the aforementioned target pressure limit (as detected by the pressure sensors 150) is not reached within a pre-determined amount of time (e.g., 120 seconds) from when inflation was initiated, the controller 20 may deactivate the current sequence (e.g., the aforementioned “normal mode” or “clearing mode”). Accordingly, the aforementioned method may further include generating a low-pressure or leak alarm and deactivating a current treatment sequence when a target pressure is not reached within a pre-determined amount of time from inflation to inflation between chambers of the bladder 30. In some embodiments, the aforementioned method further includes disconnecting the controller 20 from the dock 22 and coupling the charging port 70 of the controller 20 to the external power source 180 in order to recharge the power supply 132 of the controller 20.

Thus, although there have been described particular embodiments of a new and useful DEVICES AND METHODS FOR MULTI-CHAMBER PNEUMATIC COMPRESSION, it is not intended that such references be construed as limitations upon the scope of this invention except as set forth in the following claims.

What is claimed is:

1. A compression device, comprising:
a sleeve including:
a sleeve body,
a bladder having a plurality of chambers, and
a dock in fluid communication with the plurality of chambers; and
a controller removably attached to the dock, the controller including:
a controller body,
one or more pumps in fluid communication with the dock, and
a locking mechanism positioned to secure the controller to the dock.

2. The device of claim 1, wherein the plurality of chambers each include a corresponding chamber port of a plurality of chamber ports.

3. The device of claim 2, wherein the dock includes a plurality of dock ports, each dock port of the plurality of dock ports in fluid communication with a corresponding chamber port of the plurality of chamber ports.

4. The device of claim 3, wherein the controller includes a plurality of controller ports, each of the controller ports in fluid communication with the one or more pumps, and
wherein each of the plurality of controller ports are in fluid communication with a corresponding dock port of the plurality of dock ports when the controller is secured to the dock.

5. The device of claim 4, wherein the plurality of dock ports engage the plurality of controller ports in a press-fit arrangement when the controller is secured to the dock.

6. The device of claim 4, wherein each of the plurality of controller ports form a recess on a surface of the controller, and
wherein each of the dock ports protrude from a surface of the dock, forming a protrusion profile that matches a recess profile formed by each of the plurality of controller ports.

7. The device of claim 4, wherein the plurality of dock ports includes at least three dock ports, and
wherein the plurality of controller ports includes at least three controller ports.

8. The device of claim 4 wherein the plurality of dock ports includes at least six dock ports, and
wherein the plurality of controller ports includes at least six controller ports.

9. The device of claim 4, wherein the sleeve further includes a plurality of tubes, and
wherein each of the plurality of tubes fluidly couple a corresponding dock port of the plurality of dock ports to a corresponding chamber port of the plurality of chamber ports.

10. The device of claim 1, wherein the controller further includes:
a power supply; and
a charging port in electrical communication with the power supply, the charging port configured to be connected to an external power source and re-charge the power supply.

11. A method of compressing a body part, the method comprising:
at least partially surrounding a limb with a sleeve body of a sleeve, the sleeve further including:
a bladder having a plurality of chambers, and
a dock in fluid communication with the plurality of chambers;
positioning a controller on the dock, the controller including:
a controller body,
one or more pumps in fluid communication with the dock, and
a locking element disposed on the controller body;
moving the locking element from a released position to an engaged position where the locking element secures the controller to the dock; and
activating the one or more pumps, such that the at least one chamber of the plurality of chambers is inflated.

12. The method of claim 11, wherein the plurality of chambers each include a corresponding chamber port of a plurality of chamber ports.

13. The method of claim 12, wherein the dock includes a plurality of dock ports, each dock port of the plurality of dock ports being in fluid communication with a corresponding chamber port of the plurality of chamber ports.

14. The method of claim 13, wherein the controller includes a plurality of controller ports, each controller port of the plurality of controller ports in fluid communication with the one or more pumps, and
wherein each controller port of the plurality of controller ports are in fluid communication with a corresponding dock port of the plurality of dock ports when the controller is secured to the dock.

15. The method of claim 14, wherein the plurality of dock ports engage the plurality of controller ports in a press-fit arrangement when the controller is secured to the dock.

16. The method of claim 14, wherein each of the plurality of controller ports form a recess on a surface of the controller, and
wherein each of the dock ports protrude from a surface of the dock, forming a protrusion profile that matches a recess profile formed by each of the plurality of controller ports.

17. The method of claim 14, wherein the plurality of dock ports includes at least three dock ports, and
wherein the plurality of controller ports includes at least three controller ports.

18. The method of claim 14 wherein the plurality of dock ports includes at least six dock ports, and
wherein the plurality of controller ports includes at least six controller ports.

19. The method of claim 12, wherein the sleeve further includes a plurality of tubes, and
wherein each of the plurality of tubes fluidly couple a corresponding dock port of the plurality of dock ports to a corresponding chamber port of the plurality of chamber ports.

20. The method of claim 11, wherein the controller further includes:
a power supply; and
a charging port in electrical communication with the power supply, the charging port configured to be connected to an external power source and re-charge the power supply.
